(19) United States
(12) Patent Application Publication
(10) Pub. No.: US 2012/0197657 A1
(43) Pub. Date: Aug. 2, 2012

(54) SYSTEMS AND METHODS TO FACILITATE MEDICAL SERVICES

(75) Inventor: Srdan Prodanovic, Naples, FL (US)

(73) Assignee: EZ Derm, LLC, Naples, FL (US)

(21) Appl. No.: 13/017,602

(22) Filed: Jan. 31, 2011

(51) Int. Cl. G06Q 50/00; G06Q 10/00

(52) U.S. Cl. 705/2

(57) ABSTRACT

Systems and methods related to efficient practice of medicine, with a particular focus in the dermatologic field. The systems methods described herein rely on teamwork in which all of the participants (patients, medical staff and medical care providers) contribute to the medical visit, medical record generation, and billing for the visit. The systems and methods include three aspects, which are referred to herein as portals: 1) a patient portal 130, which allows patients to interact with the system; 2) a clinical portal 150, which serves as a medium in which medical staff and providers interact with the system, and 3) a billing portal 170, which serves as a medium in which the medical providers and billing personnel interact with the system.

### BACKGROUND

The subject application generally relates to the use of a computer-based application to facilitate medial treatment of a patient. In one particular example, different portals are employed by the medical provider, support staff, and patient to provide an efficient treatment experience. It will be appreciated that the described techniques may find application in other systems and/or other methods.

Prior to the recent era wherein medical insurance became the major reimbursement force in medicine, medical providers dedicated a majority of her/his time on patient care. Such care included diagnosis and treatment of medical condition(s) and not reimbursement-related medical note generation. Nevertheless, in today's medical industry, insurance laws force medical providers to produce medical encounter documents for each patient under strict guidelines under the threat of significant financial and criminal penalties if these guidelines are violated. At the same time, the demand for medical services is ever increasing, especially for certain specialties. For instance, from 1974 to 2000, the number of visits to dermatologists nearly doubled, from 18 million to 35 million per year, Yet, the number of dermatologists is limited, leading to overall dermatology shortage, and the mean wait times for a new patient to see a dermatologist of 66 days. Some dermatologists see an excess of 100 patients a day, which equates to 4.8 minutes of interaction with a patient in an 8-hour workday.

Moreover, a dermatologist must manage a burden of paperwork necessary to for each patient visit. These time constraints reduce not only the number of patients that a dermatologist can see but also the quality of time that a dermatologist can spend with a patient addressing her/his dermatologic needs. In short, this burden takes away the time dermatologist has to properly examine, assess, perform a procedure and treat the patient.

Current EMR/EHR systems rely on unintuitive data entry in which an MD has to be a very good typist to complete a note. They also use templates to shorten the time necessary to complete the note. The fallacy of a template is that no patient is the same and templates do not fit all the patients. What is even more, once the data is entered in the system, this data is inactive and cannot be used as information, which the software system can further use to perform other algorithms and help clinicians properly treat patients. An analogy is that of an image of a PDF document. In order to find a word in the document, the PDF software need to perform OCR of the image, recognizing the fonts. Only once the OCR is done, the computer software is able to search the words of the text and performs programmed tasks with the words, and only then the data becomes information that a software can use. Similarly, our data is structured in the database so that the entered information is not just a passive text (data), but rather active information with a meaning that can be further used by the software system to aid clinicians in patient management.

Thus, systems and methods are needed to overcome these deficiencies, to provide an intelligent computerized system that will efficiently streamline patients' visits, documentation and care, while avoiding medical mistakes, and allow for more complete medical documentation.

### BRIEF DESCRIPTION

Systems and methods related to efficient practice of medicine, with a particular focus in the dermatologic field. The systems methods described herein rely on teamwork in which all of the participants (patients, medical staff, and medical providers) can communicate information to facilitate comprehensive and efficient medical attention, diagnosis, medical record generation, and billing for the visit.

### BRIEF DESCRIPTION OF THE DRAWINGS

FIGS. 1-30 illustrate various aspects of the systems and methods described herein.

### DETAILED DESCRIPTION

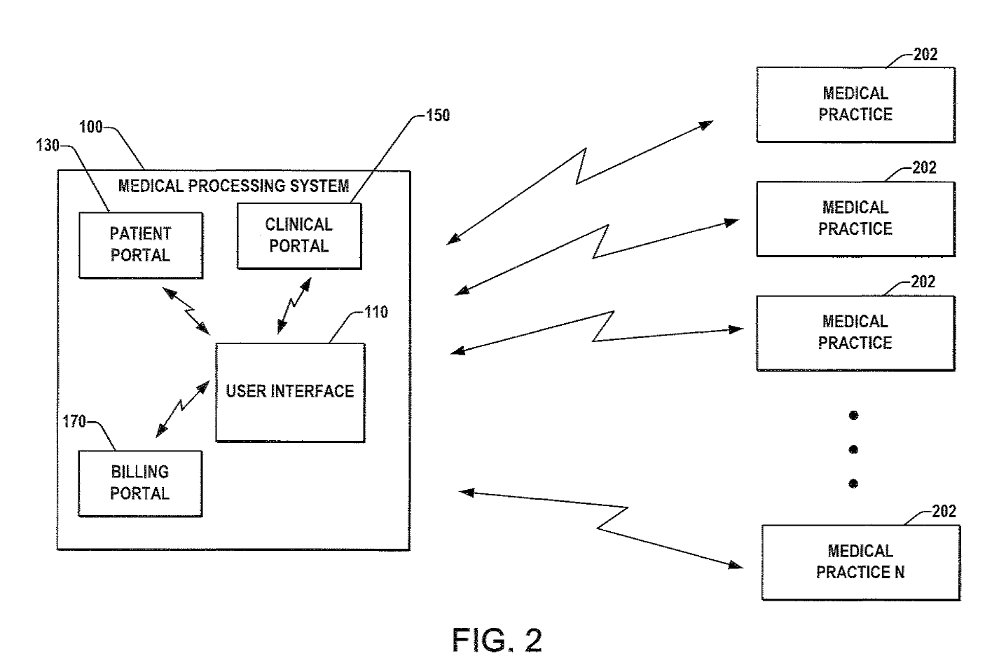

The subject invention relates to a medical processing system (MPS) that is used by medical providers, medical staff, and/or patients to facilitate efficient examination, diagnosis, and treatment of patients and the billing thereof to an insurance company for services rendered. Information can be entered into different facets of the MPS via a user interface 110. For example, a patient can utilize a system to enter medical survey information prior to an appointment with a medical provider. Similarly, a medical provider can enter data related to observed conditions, differential diagnoses, and treatment of such conditions during a patient visit. Services provided by the medical provider can subsequently be billed electronically to a third party (e.g., insurance company) by medical staff. As illustrated in FIG. 2, the MPS can be employed by a plurality of different medical practices 202 to provide administration and execution of efficient medical services.

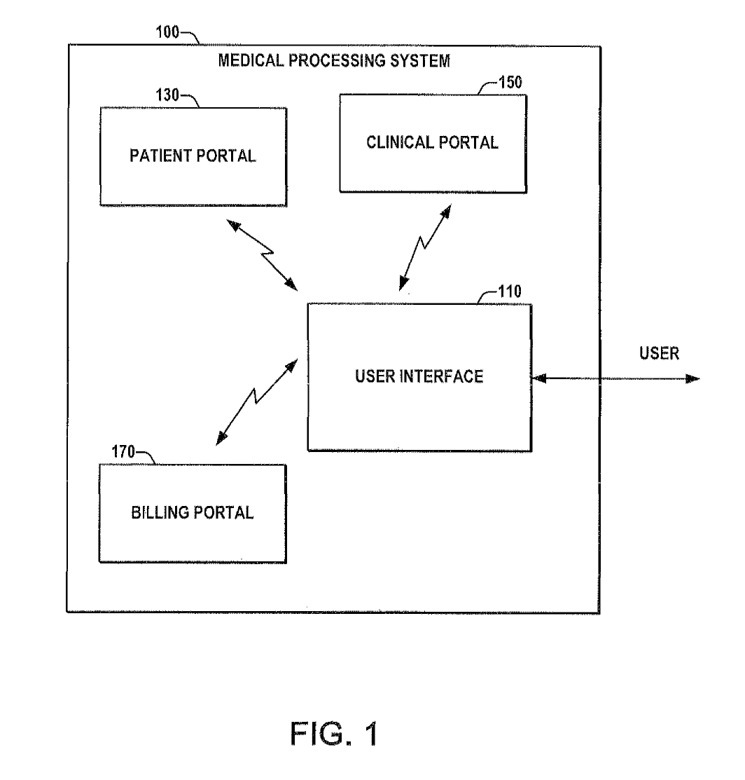

FIG. 1 illustrates an exemplary MPS 100, which is comprised of a plurality of portals each directed to a particular aspect of a medical practice. Each portal can be designed to elicit information from the respective user. In this example, the MPS 100 contains three portals: a patient portal 130—used by a patient, a clinical portal 150—used by a medical provider, and a billing portal 170—used by medical staff, to obtain and communicate information related to each respective aspect of medical care. A user interface 110 is employed by a user to communicate with each portal 130, 150, and 170 to view, edit, and enter data related to each portal.

For the sake of brevity, the systems and methods described herein are described in relation to a dermatological medical practice. It will be appreciated by one skilled in the art, however, that the MPS 100 can be employed for the administration of efficient care to patients within any medical practice or specialization. In addition, the MPS 100 can be implemented via known software platforms, languages, and modalities. In one example, the MPS is implemented as a SaaS (software as a service) solution to dermatology practices. The software can be customized (e.g., limit access to one or more modules) on a practice-by-practice basis.

The MPS 100 can help minimize the amount of time a dermatologist spends with the system, and to transfer the work to medical staff and patients, thus allowing doctors to focus on direct interaction with patients. This is achieved by providing an effective user interface 110 for data entry, quick access to information that's needed at any given time, and integration with data feeds and APIs from 3rd party providers (insurance claims, electronic prescriptions, etc.).

in one example, the patient portal 130 can be used to obtain a current patient complaint, medical history, lifestyle, known allergens, etc. In turn, this patient portal 130 data can be viewed by the medical provider prior to the visit to provide efficient medical services by understanding patient needs a priori. Similarly, a medical provider can use a clinical portal 150 within the MPS during a patient visit to assist in medical examination. For example, the clinical portal 150 can facilitate the storage, viewing, and editing of each patient's medical record. The clinical portal 150 can further provide a plurality of interfaces, drop-down menus, radio buttons, etc. that allow a medical provider to readily identify particular symptoms, provide a differential diagnosis, and recommend treatment thereof. Data related to patient treatment can be ported to the billing component for packaging and delivery to third parties for processing and delivery of invoices related to such services.

The patient portal 130 is used by a patient within the MPS 100 to answer a set of questions that are algorithmically chosen based on patient selection of a primary dermatologic complaint (e.g. a rash). The system can use the answers to generate a list of differential diagnoses. The ranking of these differential diagnoses can be based on the number of matching perimeters entered by the patient. This artificial intelligence can provide a tool for the medical provider to compliment his/her medical knowledge and remind him/her of potentially obscure conditions that they may have forgotten and/or may have not been exposed to for a long period of time. In one embodiment, data from an outside source (e.g., medical references) is employed within an algorithm to provide a ranked listing of recommended treatments that are associated with particular diagnoses.

The clinical portal 150 allows a medical provider to enter information related to medical treatment of a patient. Such data can include symptoms, differential diagnoses, and treatment prescribed in response thereto. After selection of a disease condition for a patient, the system can display a list of therapies that are stored in a therapy database within the system. The treatment list may be sorted based on the evidence based medicine data that is available or based on the provider preference of the treatment strategies. In addition the MPS 100 can list prescription medications as well as over-the-counter medications that are to be used to provide appropriate treatment for each patient. In one embodiment, the treatments can be provided to a user via an auto-complete function of the database. Once the medication is in the system, the system checks for possible interaction with the other medications that the patient is already using or is to be prescribed by the provider to use.

The clinical portal 150 can also include a 3-dimensional body mapping component to locate and identify conditions anywhere on the human anatomy. Anatomical locations can be further linked with a list of possible diagnoses and skin lesion types (including the color, morphology, distribution, etc). Such locations and corresponding conditions can automatically associated with the International Statistical Classification of Diseases and related health problems (i.e., ICD-10). A further use of the 3-dimensional component is to record distribution and coverage of a condition over an anatomical region. This information can be used to automatically calculate body surface area (BSA) and/or PASI scoring more accurately than conventional means.

The billing portal 170 can use information entered into the MPS by patients and medical providers to generate invoices for services rendered, including office visits, diagnosis of particular conditions and therapies and/or treatments thereof. The ICD-10 codes associated with each diagnosis can be processed by the billing portal wherein a CPT code is associated based upon the treatment utilized for such condition. This information can be used to generate hardcopy and/or electronic invoices for medical services, which are transmitted to an outside party, such as an insurance company, for timely payment. As ICD-10 codes are standardized for international health care systems, the MPS 100 can be employed in any location worldwide.

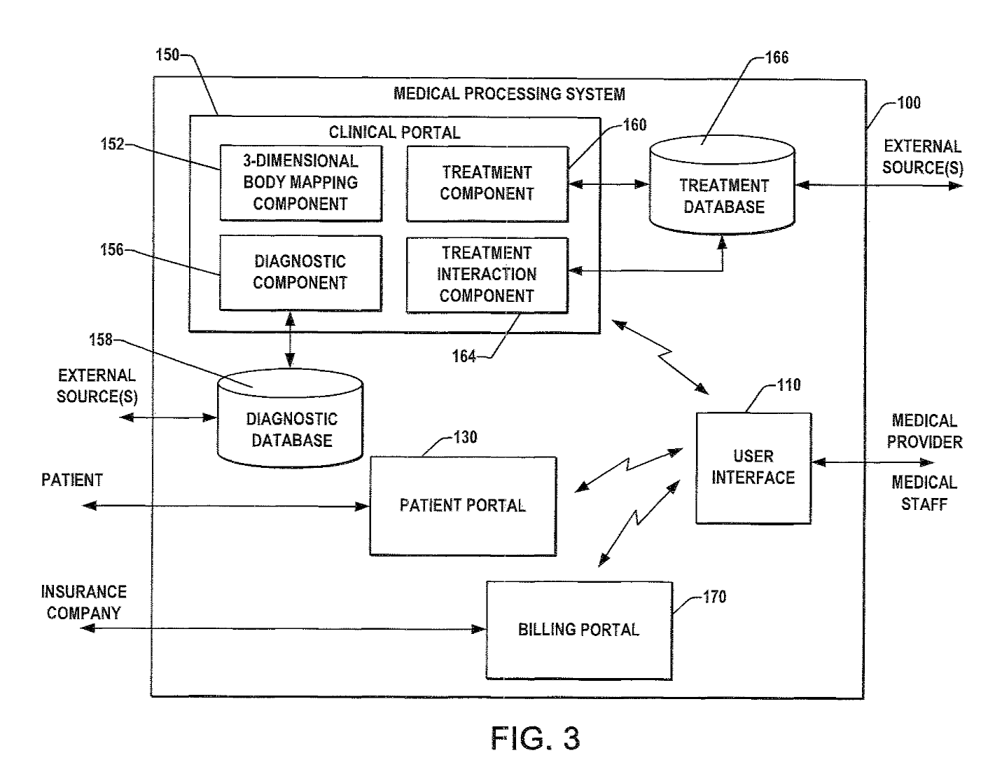

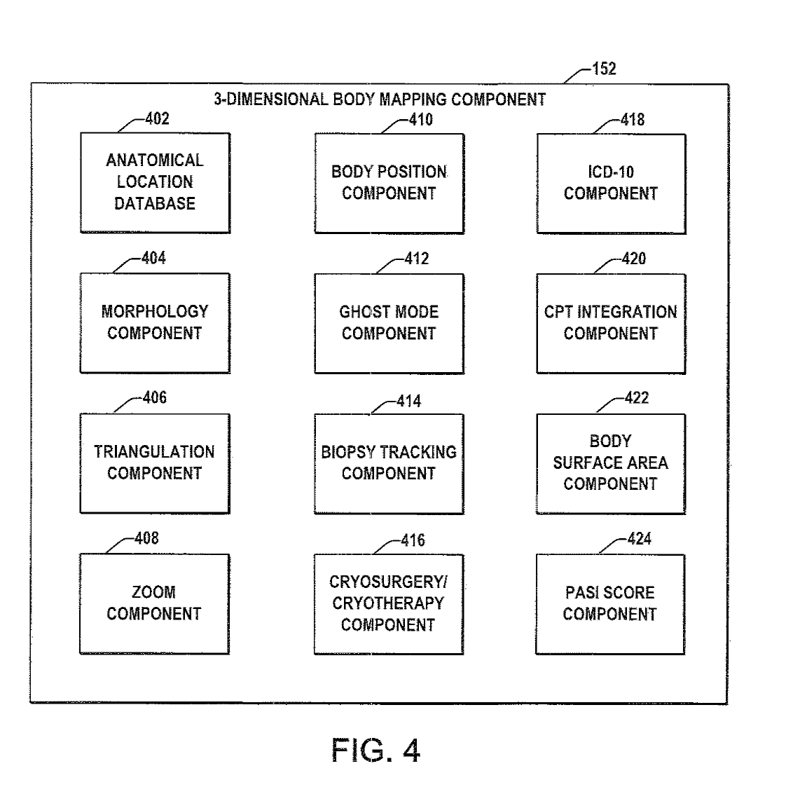

FIG. 3 illustrates a detailed view of the MPS 100 set forth in FIG. 1, wherein additional components are included in association with the clinical portal 150 to provide additional functionality for a medical provider. The clinical portal includes a 3-dimensional mapping component 152, a diagnostic component 156, a treatment component 160, and a treatment interaction component 164. These components can allow a medical provider to identify a condition on an anatomy, provide a differential diagnosis of such condition, and provide a recommended treatment for such condition that does not have any known negative interactions with other treatments (e.g., medications). A diagnostic database 158 can interface with the diagnostic component 156 to provide a lookup table or other data set of diagnoses associated with particular medical conditions. Such diagnoses can be obtained from external sources such as MedLine, or other medical publications or references. The diagnostic database 166 can also contain a listing of ICD-10 codes (or equivalent) to correlate diagnoses with an appropriate internationally standardized code. Similarly, known treatments for such conditions and treatment interactions can be stored in a treatment database 166 for subsequent retrieval by both the treatment component 160 and the treatment interaction component 164.

In one embodiment, the MPS 100 can generate a medical note that is used to document an encounter between the medical provider and the patient, usually a linear progression of the write-up is used. In this approach, different parts of the medical note are completed in a sequential order, as follows:

History→Diagnostics→Physical Examination→Assessment→Plan→Medical Coding and Billing

Nevertheless, an intellectual process of clinical reasoning follows a non-sequential flow. A medical provider interviews a patient, reviews any diagnostic data (e.g., laboratory and diagnostic imaging findings), performs a physical examination of the patient, and arrives to a clinical diagnosis in his mind. This all occurs prior the medical provider has time to document the findings in the medical note. In this regard, the MPS 100 can help the medical provider to complete documentation in a significantly quicker way than conventional means. The MPS 100 facilitates such efficiency via database relationship tables that link clinical diagnoses to:

1. Sets of corresponding physical exam findings, including skin morphologies (e.g., via the 3-dimensional mapping component 152 and the diagnostic component 156).

2. Sets of corresponding treatments (via the treatment component 160)

3. Sets of corresponding investigational studies (including but not limited to laboratory studies, histological studies, and/or imaging studies) (stored in the treatment database 166)

4. Sets of corresponding ICD-9 and ICD-10 Codes (stored in the diagnostic database 158)

5. Sets of corresponding CPT Codes (associated with the treatment via the billing portal 170)

As a result, when a medical provider interview a patient, reviews any diagnostic data, performs a physical examination of the patient, and arrives to a clinical diagnosis in his mind, he/she chooses a corresponding clinical diagnosis which is provided by the MPS 100 to the medical provider.

For example, if a medical provider concludes that a patient has psoriasis, the diagnosis of psoriasis is selected and the medical provider is offered with the following

1. Physical Findings: a well-circumscribed pink erythematous plaque (or papule) with a silvery white scale.

2. Treatments: Etanercept, Humira, Infliximab, etc.

3. Investigation Studies: Complete Blood Cell Count, Complete Metabolic Profile, Plain X-Ray Radiography of the Hands and Fingers, etc.

4. ICD-9 (ICD-10) Codes: 696.1 (L40.0)

5. Punch Biopsy of Skin CPT Codes: 11100, 11101

Patient Portal 130

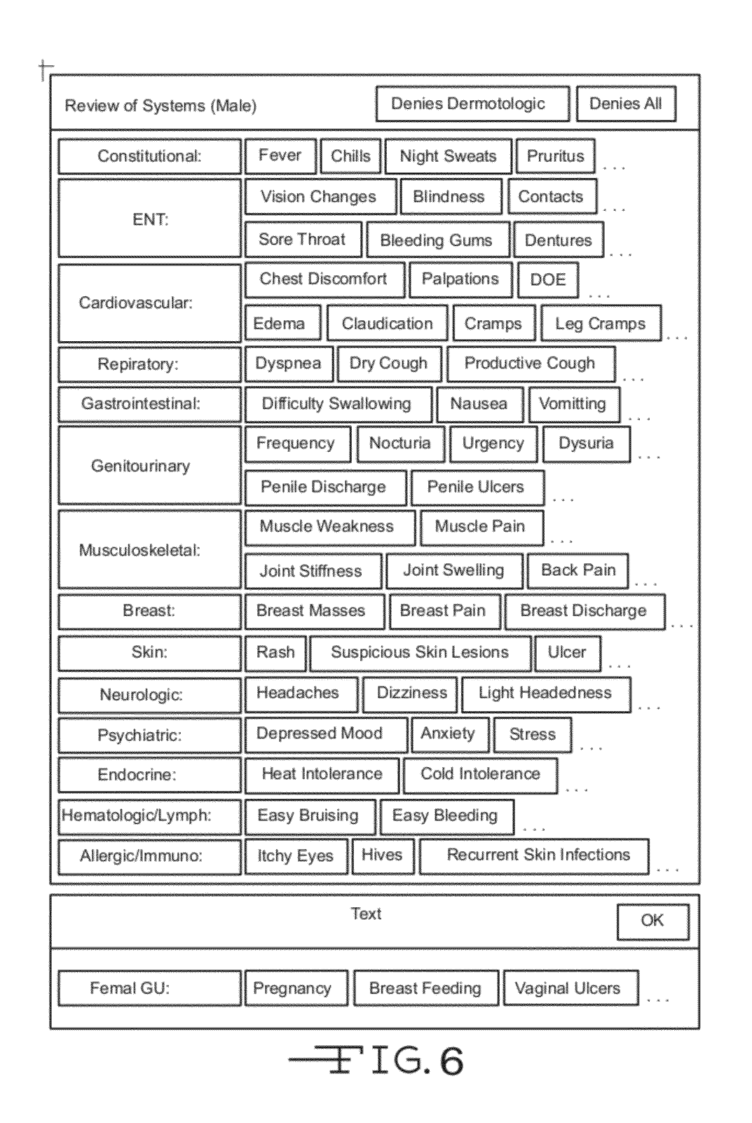

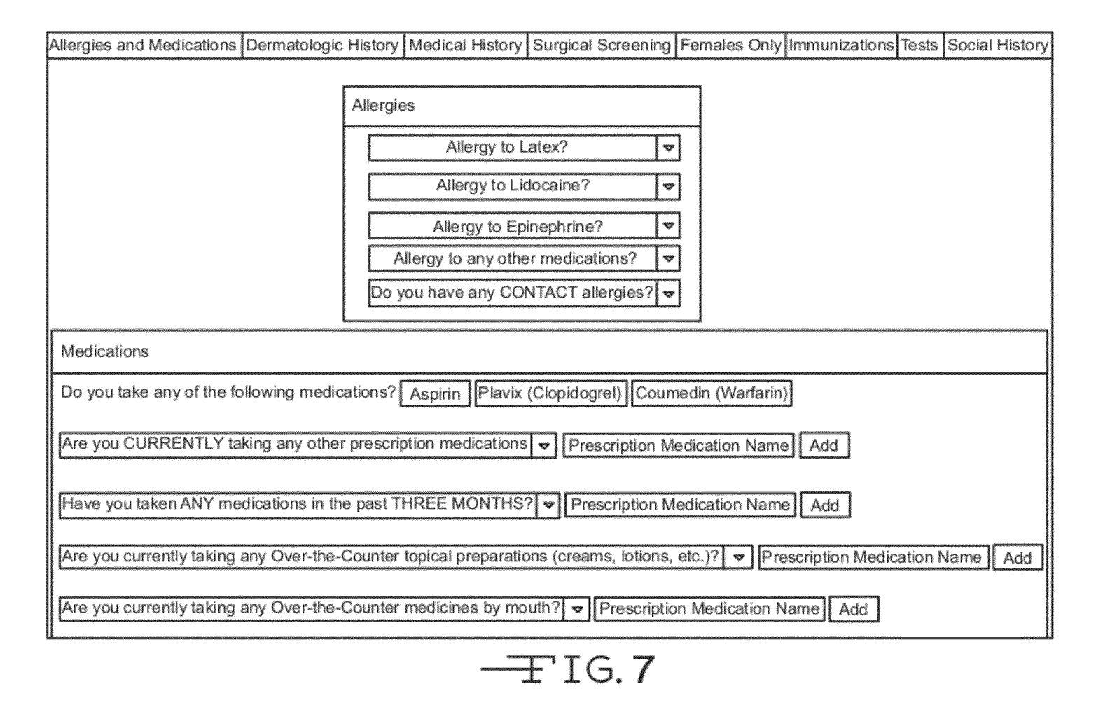

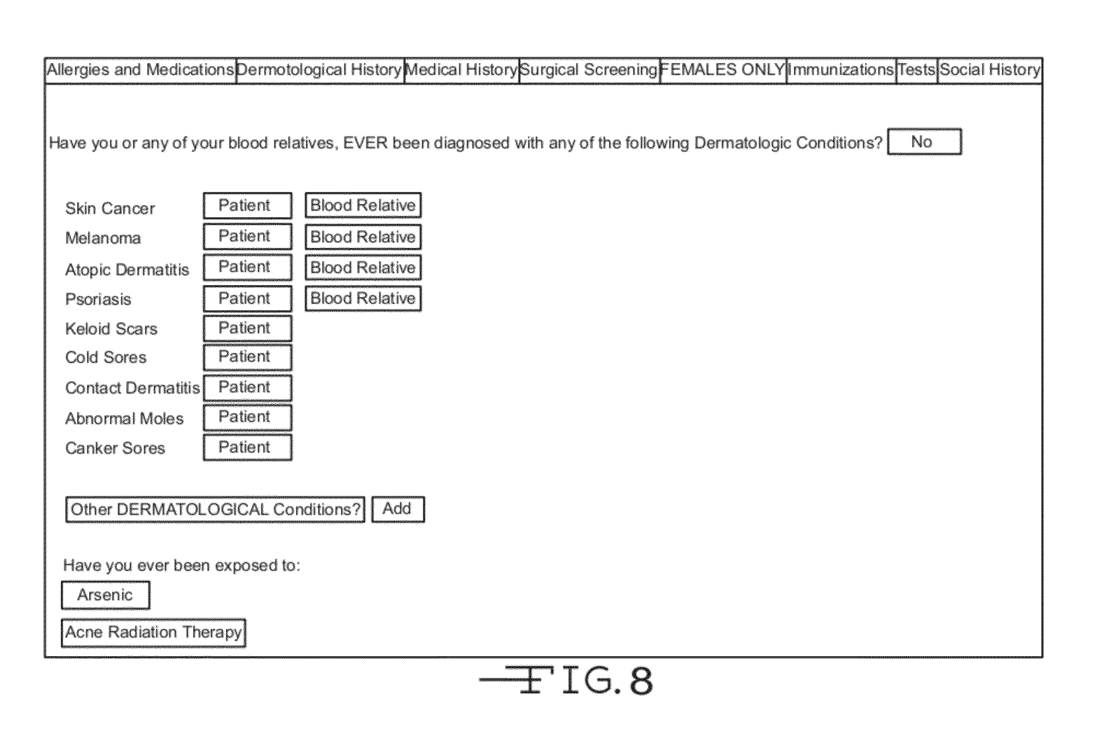

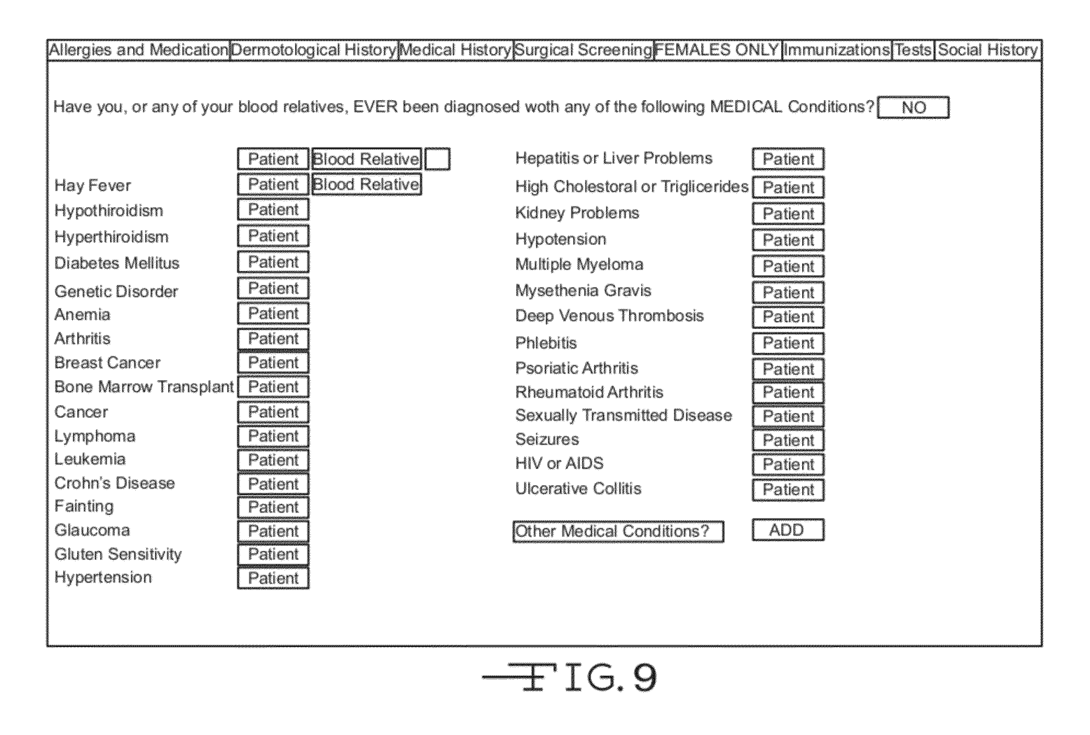

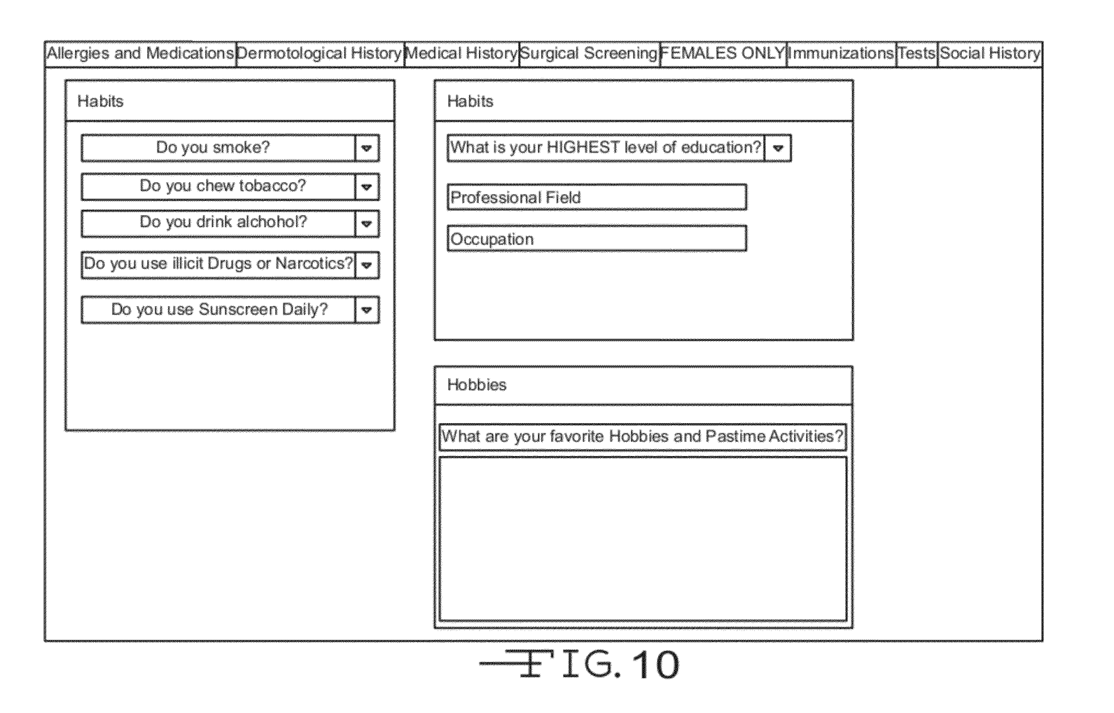

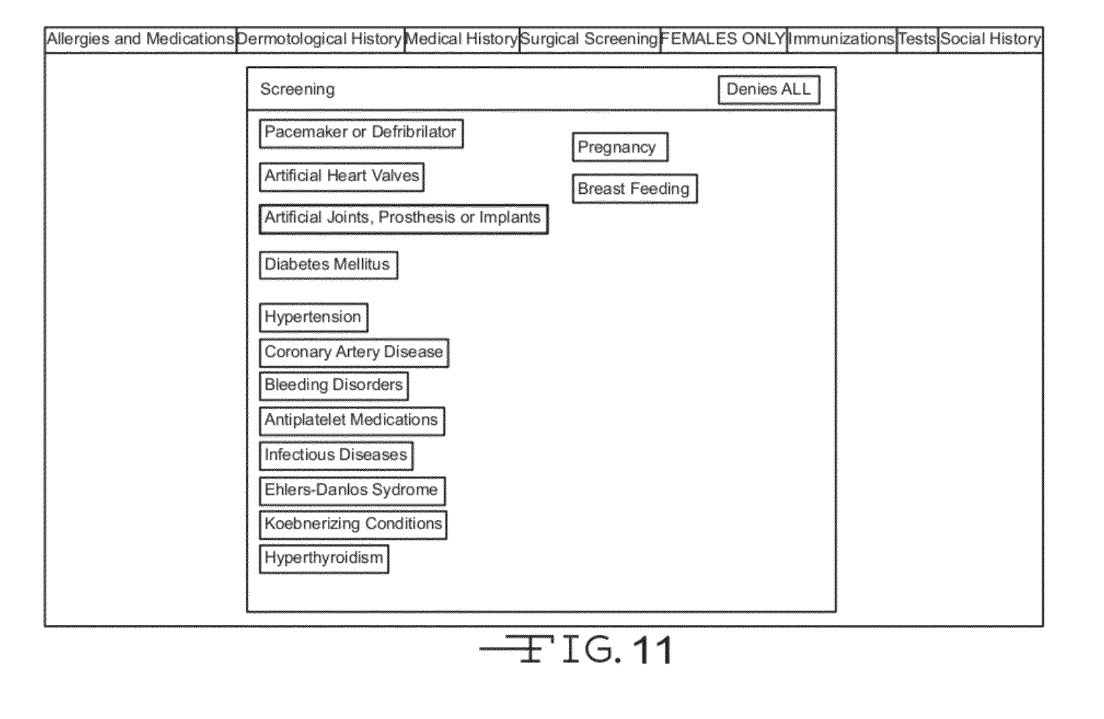

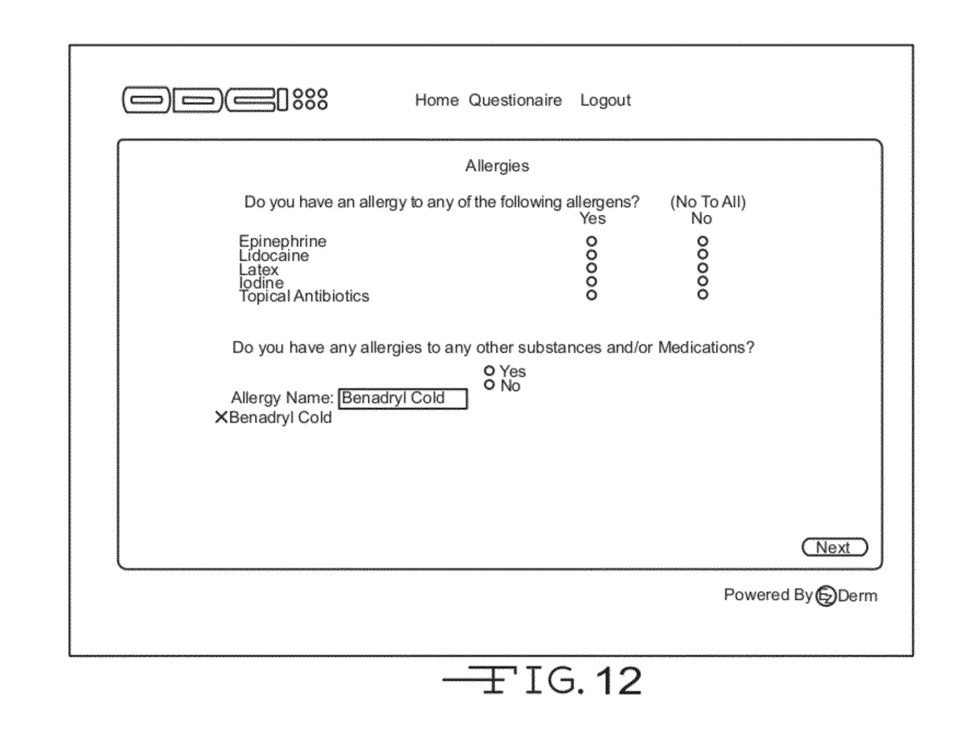

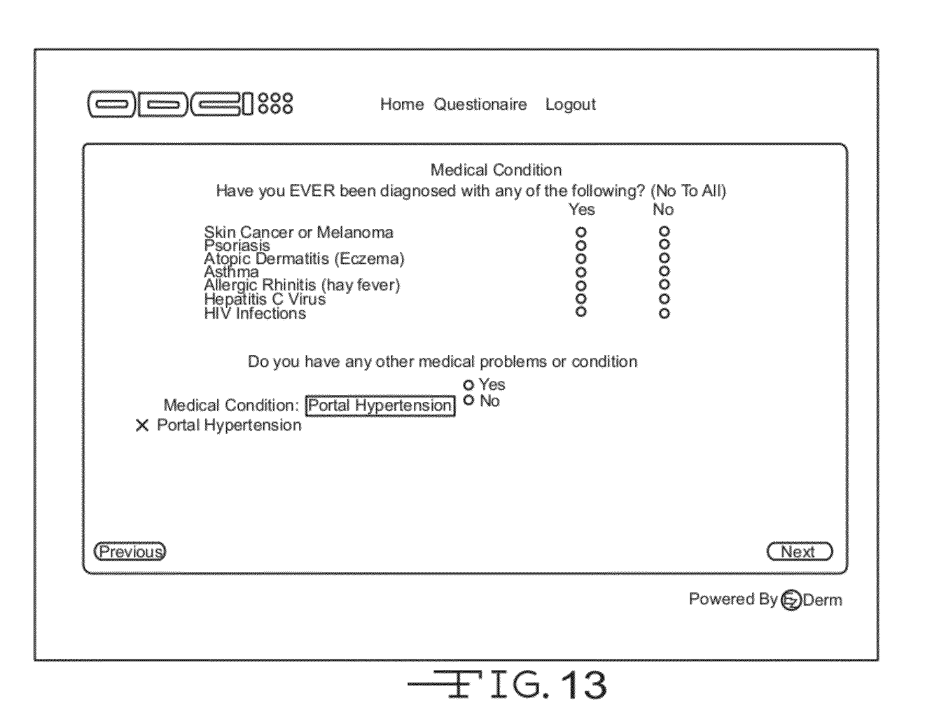

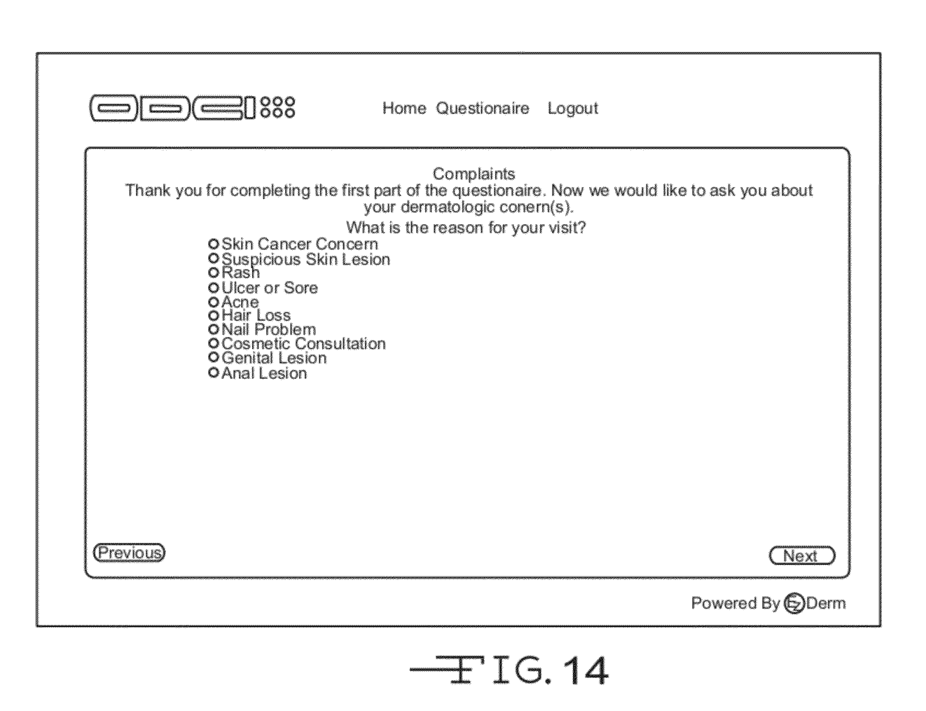

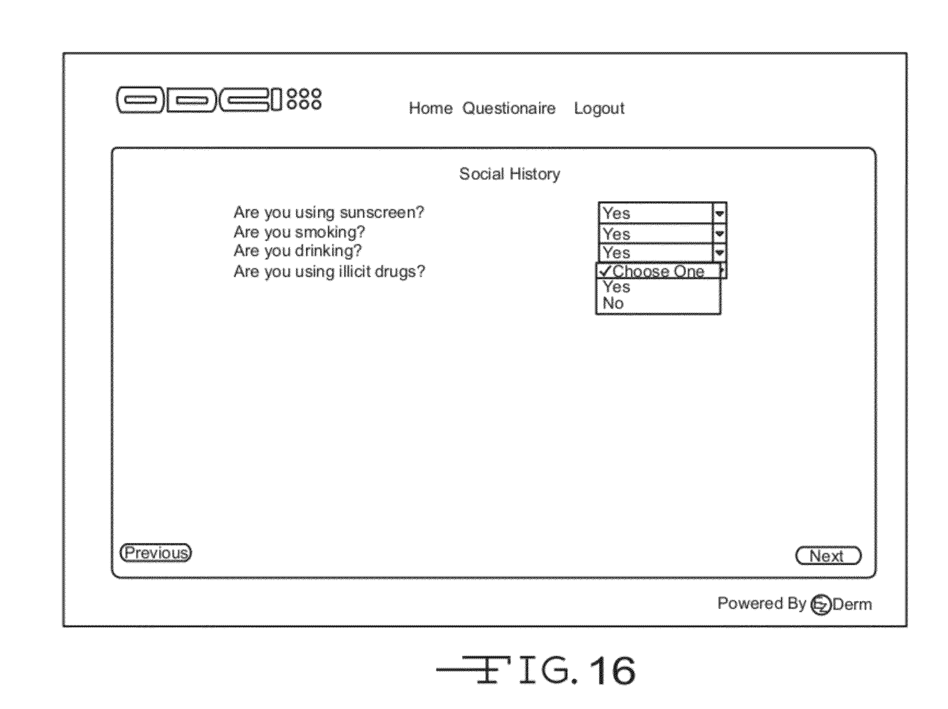

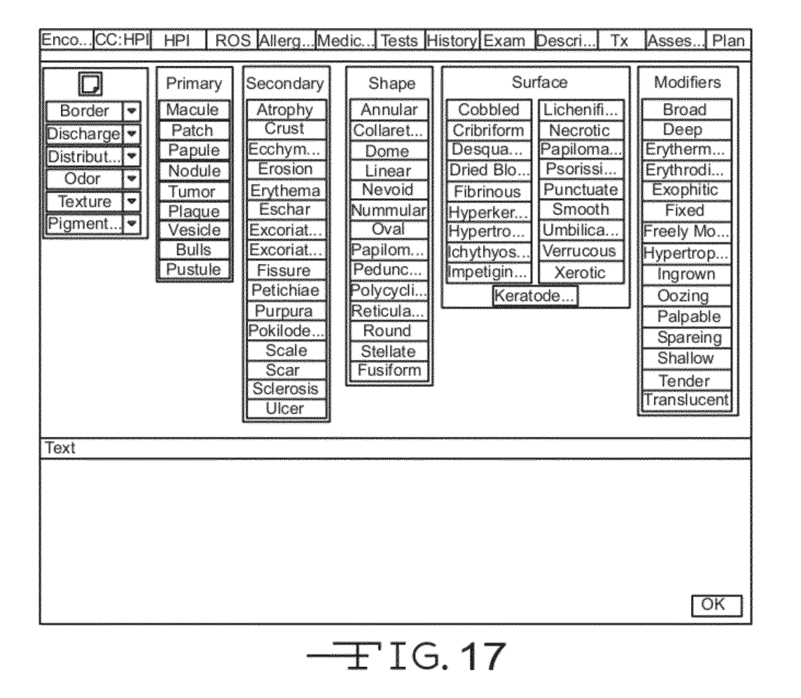

A first aspect of the system is a patient portal 130, which allows a patient to answer health related questions, view medical and/or billing records, or otherwise interact with the system, FIGS. 6-16 set forth questions for a patient to obtain information related to their current medical complaint, social habits, medical history and family medical history. The medical professional can use the extraction of such information an efficient and productive medical treatment experience.

a. Interviews the patient in an algorithmic way, inquiring about the patient symptoms and signs.

b. It allows the patient to enter only a limited number of dermatologic complaints, allowing the system algorithms to accurately interview the patients based on the dermatologic complaint.

c. Allows the patient to only enters medications from the First Data Banks list of medications that are available on the USA market, precluding a mistake in medication spelling, which can result in an eventual mistake of erroneous medication-to-medication interactions.

d. Allows the patient to answer dermatology relevant information about her/his Past medical history, Past Surgical History, Hospitalizations, Allergies, Social History, Family History, etc.

e. Again, instead of the free typing text boxes, our system only allows limited, predetermined list of allergies, medications, and disease conditions to be used, avoiding not only the room for mistake but also using the entered data as an information that the system can further incorporate in its logistics to help clinicians arrive with appropriate Diagnosis, Differential Diagnosis, and Medical Management strategy, without losing time on unnecessary data entry. Rather, maximizing the time on data processing and patient management.

For instance, selection of Itch (medical term: Pruritus) as a symptom in the History of Present Illness that the patient may experience, will display a list of potential dermatologic conditions that are associated with Pruritus in our database (see below). This approach aids dermatologist in his quest to arrive to the correct diagnosis in a limited time he/she has with the patient.

Complaints Review

Complaint (aka Presenting Problem) is a concise statement describing the symptom, problem, condition, diagnosis and other factors that constitute the reason for the encounter, and is usually stated in the patient's words, or selected form a prepopulated list as set forth in FIG. 6.

New Complaints can be selected from a list of pre-defined complaints:

Routine Skin Exam/Skin Cancer Concern

Suspicious Skin Lesion

Rash

Ulcer/Sore

Acne

Hair Loss

Nail Problem

Cosmetic Consultation

Genital or Anal Lesion

In best-case scenario, the patient can select one or more Complaints prior to the encounter via Patient portal 130. Alternatively, Clinical Staff or Provider is able to specify Complaints before or during the encounter. Although these complaints cover the vast majority of dermatologic complaints the patients present with, the maximum number of Complaints that can be specified is defined by Software Administrators.

Patient needs to specify at least one complaint from the list—if he is not aware of any particular skin problem, he can select Routine Skin Exam/Skin Cancer Concern.

One of the complaints from the list has to be Chief Complaint, which represents the key reason why the patient came to Clinic.

In addition, this list is complemented with a follow-up on the active dermatologic problems diagnosed during previous encounters. That is, a brief assessment of the established active dermatologic problems is done on the follow-up visits. The assessment usually includes a question whether the active dermatologic problem is better, worse, or the same on the follow-up visit as it was before the treatment was started. The patient portal 130 includes an algorithmically generated questionnaire in order to assess the above. In this case, the diagnosis from the previous visit is in the list of active problems.

The system can provide users to specify History of Present Illness (HPI) for each Complaint. However, only Chief Complaint must have HPI. Patients is given a simple questionnaire for this purpose on Patient portal 130, while Providers and Clinical Staff members includes more complex UI on Clinical portal 150 where they is able to view and change each of the HPI attributes. HPI Questionnaires can depend on the selected Complaints.

History of Present Illness (HPI)

HPI is a detailed exploration of the symptoms the patient is experiencing that have caused the patient to seek medical attention. For each Complaint, there is one HPI.

HPI has eight dimensions (attributes which describe Complaint):

Location: Place, site, position of signs & symptoms. Where is the problem located?

Duration: How long has the patient been experiencing the signs or symptoms?

Signs and Symptoms: When does the patient experience signs or symptoms? What regularity/frequency of occurrences? What time of day?

Severity: What is the intensity, degree, or ability to endure signs or symptoms? Scale of 1 to 10?

Timing: What description or characteristics identify the type of signs or symptoms?

Context: Circumstances, cause, precursor, outside factors to describe where patient is or what he is doing when signs or symptoms are experienced,

Quality: What treatment/actions have affected (positive or negative) or altered the signs or symptoms?

Modifying Factors: Are there any other symptoms that appear to accompany the main symptoms? What other factors does patient experience in addition to this discomfort/pain?

Review of Systems (ROS)

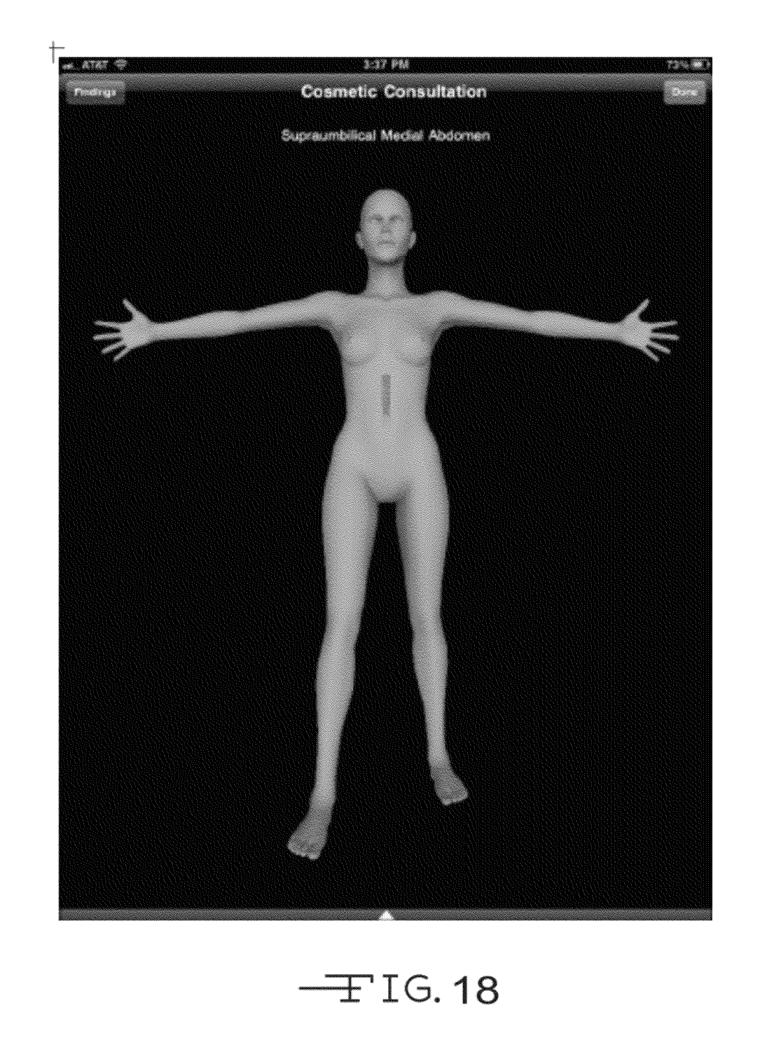

An exemplary review of systems (ROS), as set forth in FIG. 18, is an inventory of body systems obtained through a series of questions seeking to identify signs and/or symptoms which the patient may be experiencing or has experienced. Information included in the review of systems is used to identify the patient problem, assist in the arrival at a diagnosis, identify differential diagnoses, and determine the testing necessary to attain a definitive diagnosis. The ROS is designed to bring out Clinical symptoms which the patient may have overlooked or forgotten. In theory, the ROS may illuminate the diagnosis by eliciting information that the patient may not perceive as being important enough to mention to the medical provider.

CP can allow Clinical staff and providers to perform review of systems by providing them with a set of structured questions. Users are able to answer each of the questions with Yes/No answers, and to optionally provide textual description for the answer. System can also provide shortcuts, to mark all answers (or each individual system) in a specified category with No (or Yes?) answers.

The number of systems reviewed ties into the billing logic (as many other parameters do); there are no specific rules about how much provider can ask the patient about each system. This is left up to the discretion of the individual Provider.

In addition to storing answers to each question, system can provide a general Review of Systems summary in the Clinical Note.

There are three levels of ROS recognized by the E/M guidelines:

Problem Pertinent ROS requires review of one system related to current problem(s)

Extended ROS: requires review of two to nine systems

Complete ROS: requires review of at least ten systems

ROS Questions

ROS questions can be grouped in categories (‘systems’), wherein each category includes a set of questions, as provided in FIG. 6. Each question includes Yes/No answer and optional free text comment. The system can also provide the way to specify that patient denies having any of the symptoms from the list (answer to all the question is No), or that the patient denies having any of the dermatologic symptoms—for instance, there is two buttons: Denies Dermatologic and Denies All.

There can also be a way (i.e. button Denies All) to specify there that answers to all the questions are negative.

Most of the questions are for both male and female patients. However, there is a set of questions that are gender specific only for male/female patients.

Below is the list of categories, and related questions:

Constitutional: Fever, Chills, Night Sweats, Pruritus, Fatigue, Loss of Appetite, Weight Loss

ENT: Vision Change, Blindness, Contacts, Ear Discharge, Ear Ache, Nosebleeds, Mouth Ulcers, Sore Throat, Bleeding Gums, Dentures, Dry Mouth

Cardiovascular: Chest Discomfort, Palpitations, DOE, Orthopnea, PND, Edema, Claudication, Leg Cramps, Varicose Veins, and Blood Clots

Respiratory: Dyspnea, Dry Cough, Productive Cough, Hemoptysis, Wheezing

Gastrointestinal: Difficulty Swallowing, Nausea, Vomiting, Diarrhea, Abdominal Pain, Hematochezia, Melena

Genitourinary: Frequency, Nocturia, Urgency, Dysuria, Hematuria, Kidney Stones, Incontinance, Penile Discharge, and Penile Ulcers

Musculoskeletal: Muscle Weakness, Muscle Pain, and Difficulty Combing Hair, Difficulty Rising from Chair, Joint Pain, Joint Stiffness, Joint Swelling, and Back Pain

Breasts: Breast Masses, Breast Pain, Nipple Discharge

Skin: Rash, Suspicious Skin Lesion, Ulcers

Neurologic: Headaches, Dizziness, Light Headedness, Fainting, Paralysis, Numbness

Psychiatric: Depressed Mood, Anxiety, Stress, Manic Episodes, and Suicidal Ideations

Endocrine: Heat Intolerance, Cold Intolerance, Excessive Sweating, P-dypsia, P-phagia, P-uria, Weight Gain

Hematologic/Lymph: Easy Bruising, Easy Bleeding, and Enlarged Lymph Nodes

Allergic/Immuno: Itchy Eyes, Easy Bleeding, Enlarged Lymph Nodes

Through the Patient portal 130, new patients are able to enter necessary information ahead of their first visit. This can reduce the time spent in the Clinic, as well as reduce the data entry time for the Clinic's staff. Patients can also be able to confirm their appointments and access limited information from their personal medical health record. Demographics of the target audience for the Patient portal 130 can vary significantly. Using the MPS 100 in general and the patient portal in particular can insure that correct information is obtained from the patients in an organized and logical way. This information can serve not only for future correspondence with the patients and medical billing, but also for the medical decision making. If the patient fails to provide requested information, the Clinical staff can enter this information upon the patient's arrival to the Clinic. In one embodiment, the patient portal 130 and the clinical portal 150 share the same database. Hence, all information entered in the patient portal 130 is available and editable on the clinical portal 150. Audit log can keep track on the database, level, meaning that authorized users is able to see even the changes made by patients on patient portal 130.

Patient portal 130 can support the following:

User (patient) registration and login

User profile management

Insurance information management

Medical history management

Pre-visit questionnaires

Registration and Login

New users can somehow need to be added into to system. This can be done manually from the Clinical portal 150, and is typically performed by the Clinical staff. In a typical use case scenario, new patient would first call the Clinic in order to schedule the appointment. Administrative staff can ask for required contact information (including E-mail), which is needed to create the patient record, and can ask when the patient would like to come to the Clinic. Staff can then create the patient record and schedule the appointment. Upon creating the patient record, the Clinical portal 150 can then automatically send an email to the patient, with a salted link that can lead the patient to the registration page on the Patient portal 130 where patient can fill registration form (enter basic information and the password). After successful registration, the patient is able to access Patient portal 130, and is able to see the scheduled appointment.

When creating new Patient record, administrative staff includes to fill in at least following information:

First, Middle (optional) and Last Name

Date of Birth

Social Security Number

Insurance Information

E-Mail (unique for each patient)

Phone Number

If a patient has insurance(s), then the administrative staff can prompt the patient about insurance information. For each insurance company, patient needs to provide name of the insurance company and the insurance ID. The system would provide a drop down list for selecting Insurance Company (or similar UI control) containing all insurance companies available in the database. if company is not found in that list, then the staff includes the option to add a new company (there is a shortcut for add new company).

On the Patient portal 130, there is Register link, which would lead the patients to registration page. However, this cannot allow them access to Patient portal 130 instantly. Each registration request includes to be reviewed by administrative staff. Once registered, patient is able to login to Patient portal 130, and enter availability for the appointment, complaints, HPIs, ROS, etc.

Registration Form

Registration form can typically contain:

First, Middle (optional) and Last Name

Date of Birth

Social Security Number

Insurance Information

E-Mail (unique for each patient)

Phone Number

Password (and Password Confirmation)

In the scenario where the member of the staff entered information about the patient during the phone conversation, most of the fields is pre-populated when the patient comes to this page. He can only have to review this information (and change something if required) and to enter the password.

Login Form

Login form can present users with the two input elements (E-Mail, Password), “Remember Me” checkbox (remembers users login for 2 weeks), and Forgot Password link that opens a popup window with the input field for the email (see Forgot Password section).

If users provide wrong E-Mail and/or password, the system can present them with the same form and the error message “We were not able to identify email/password combination you've entered. Please try again.”

Authentication system are setup so that if the user obtains a link to a page (e.g. via email sent from the system), the system checks if the user is logged-in, if not presents them with the login page, and upon successful login redirects them back to the originally requested page.

General Information

General information page can contain subset of the corresponding page on the Clinical portal 150, as shown in FIG. 39A. There can also be an option to provide additional info, such as: Contact Information: Home phone, Mobile Phone, Work Phone, Email, Address (Street, City, State, ZIP; target market is US, so we can assume country to be the US)

Additional Contact Information (same fields as above)

Emergency Contact: First Name, Last Name, Phone number, Alternative phone number, Relationship (to patient)

Historic Information (prior names, addresses, phone numbers and email addresses)

Employment Information (select/specify info bellow)

Retired

Unemployed

Patient Occupation

Patient Employer

Employment Address

Patient Work Phone

Demographic

Via this page, patient is able to select

Primary language

Secondary language

Race/Ethnicity

American Indian or Alaska Native

Asian

Black or African American

Hispanic/Latino/Spanish

Native Hawaiian or Other Pacific Islander

White (Caucasian)

Other (Specify)

Medical Contact Information

Via this page patient is able to specify Primary Care Provider (PCP), Referrer or other Medical Providers (e.g. Cardiologist, Dermatologist, etc.) he/she has visited in the past. This information can be presented in an exemplary interface shown in FIG. 39B. Referrer is person or some other source that recommended a Clinic/practice/provider to the patient—can be PCP, another patient or other advertisement, website of the practice, search engine.

Insurance Information

This page allows patients to manage their insurance information. However, adding new or changing/deleting existing Insurance Policy Information would require verification on the Clinical portal 150. In other words, after making such change, patients can need to wait for administrative staff to verify this information.

Pharmacy Information

On this page patient is able to specify information about his/her (preferred) pharmacy, as shown in FIG. 41. This includes:

Pharmacy Name:

Pharmacy Address:

Pharmacy City:

Pharmacy State:

Pharmacy Phone:

Free Text Note

There can also be a text note for the patients: If you cannot locate your pharmacy information, you may find it here (hyperlink: http://www.pharmacypages.com/index.cfm

Medical Information

Medical information includes the list of Complaints, HPI for each specified complaint and Review of Systems (ROS). Also, it is important to specify if the patient wants the full body exam to be performed during the next visit. During the phone interview when patients' appointments are scheduled, the staff members obtain this information via Clinical portal. However, after the phone interview, patient is able to change this on the Patient portal 130 (i.e. in the case he forgot to mention something to the staff).

On these pages, patient is guided to fill in information necessary for the next encounter. Note that this information cannot reflect patient's medical record until provider or staff reviews the changes, which can typically be done during the visit and prior to the encounter.

Medical History

Medical History includes following sections:

Allergies

Medications

Immunizations

Illnesses

Procedures

Family History

Social History

Tests

FIGS. 46-52 provide exemplary screens for each of these categories.

General Questionnaire

Upon first sign-in to the PP, patients are prompted to provide some general information about them. This includes general and demographic information, as defined above. This questionnaire is in a form of wizard, and is optional (this information can be entered/changed later on patient profile page).

Pre-Visit Questionnaire

Pre-Visit questionnaire presents a set of questions to the patient in order to provide information about the History of the Present Illness. In a typical workflow, patient can call the Clinic and schedule the appointment. He is asked about his Chief Complaint (and possibly other complaints), HPI and ROS. Then, the system can send an email to the patient with the link to the Patient portal 130. After patient sings in to the PP, he is offered to fill in Pre-Visit Questionnaire. This questionnaire is in a form of wizard—patient is offered a page by page until he answers all the questions or until he quits. Note that this questionnaire is optional, and that it can be only partly completed. By answering to these questions, patient can speed up the process in the Clinic.

The aim of this questionnaire is to provide all or at least some of the information listed above. This information can be entered manually, on the patient profile page (as described above). Pre-Visit Questionnaire is especially important for new patients to complement the basic information entered by the staff during the phone interview. Established patients can typically have majority of the data filled already. Therefore, new patients are presented with a more comprehensive questionnaire that aims to gather all the required information.

New Patient Pre-Visit Questionnaire

Upon first sign-in and filling in General Questionnaire, new patient is presented with Pre-Visit Questionnaire in a form of wizard. New patient is offered to provide the list of complaints (first is Chief Complaint), and HPI for each complaint. Then the system can guide the patient to fill in ROS, and can offer the patient to choose whether he wants full body exam to be performed. Afterwards, the patient is prompted to answer to the set of Medical History questions (as defined in Medical History).

Established Patient Pre-Visit Questionnaire

Established patients can need to call the Clinic in order to schedule the appointment. Like new patients, they is able to specify their complaints, HPI, ROS, etc. After staff schedules the appointment for the patient, he/she is presented with the questionnaire upon next login to Patient portal 130. This questionnaire is much simpler than for the new patient. It can contain only questions (pages) that were not answered before.

Clinical Portal 150

A second aspect of the system is a clinical portal 150, which allows a medical provider to enter information related to medical treatment of a patient. Such data can include symptoms, differential diagnoses, and treatment prescribed in response thereto.

The Clinical portal 150 includes a Practice Administration section, visible only to the practice administrators, used to change practice information and settings, to add, edit or disable Clinics and users,

3-Dimensional Mapping Component

The clinical portal 150 can also include a 3-dimensional body mapping component. This aspect can mitigate the difficulty of interaction between a human being and computer is its Graphic User interface 110. The system is relying on the fact that we are using an Avatar 3D model of the human being that represents a patient. By predefining the anatomical locations, (Over 2,000 Skin Surface Anatomy areas are identified on the body), we preclude possible mistakes in naming of the body surface areas that can arise between different users, thus standardizing the nomenclature. Often, mistakes are made in naming the left/right location of the skin lesion as the provider has to refer to the patient left, rather than her/his left, for instance. By using this 3D model, the provider/staff is able to relate the patient left to that of the model much more easily, than it is possible on a 2D model or with a descriptive text. Anatomical locations are further linked with a list of possible diagnoses and skin lesion types (including the color, morphology, distribution, etc), as shown in FIGS. 62-67.

A three-dimensional body mapping component 152 can be employed within the clinical portal 150 to allow the medical provider to locate and map particular patient dermatologic conditions. Such 3-D mapping can include rotational, ghost, and zoom features to locate substantially any location on the human anatomy. Once located, a medical provider can identify particular conditions in the subject area, which can be saved for future reference. Mapping can also include the use of triangulation or other means to provided specific location information that can be related to different anatomical feature, other dermatologic features, etc. Once mapping is complete, such data can be stored in a patient medical record for subsequent retrieval.

In another aspect, once an anatomical location is identified (e.g. via 3-D mapping component), the MPS can provide a list of conditions specific to a particular anatomical region. Such listing can be based on symptoms identified by the medical provider such as color, size and scaling of a dermatological feature or other characteristics. For example, if a pustule is identified with a red color, the system can provide a dropdown list of potential conditions associated with such dermatologic feature. The medical provider can review the list and select a condition to be associated therewith. Once such a condition is identified, a subsequent list of appropriate treatments can be provided to the medical provider for selection.

In a particular example, a medical provider utilizes the 3-D mapping component to identify an anatomical location of a patient skin lesion. Such location can be related to a specific anatomical location, region, and/or distribution of condition throughout a particular area. The medical provider also enters morphology information related to the lesion, which can distinguish primary skin lesions and secondary skin lesions and also describe the shape, surface, scale, pigmentation, border, edge, texture, and/or surface of the lesion. The medical provider can enter the color and distribution of a plurality of skin lesions on a patient anatomy. This information is analyzed by the MPS 100 to provide a listing of potential diagnoses and treatments thereof.

3-Dimensional Body Mapping Component

The 3-Dimensional Body mapping component 152 is a multimedia interface featuring a full graphical 3-D map of the human body, with separate maps for male and female body, as well as different age groups (e.g., infants). The mapping component contains a plurality of components described herein to provide particular information relayed to patient condition and in association with the diagnosis and treatment thereof.

The main goal of the body mapping component 152 is to provide:

Complete and easy-to-use mode of data entry

Visual representation of the dermatologic problems (allowing medical providers to see multiple problems at the same time)

Body mapping component 152 can allow medical providers to see multiple dermatologic problems at the same time. These problems can include not only the current dermatologic problems, but also historical problems that were diagnosed in the past.

Body regions and anatomical landmarks (i.e. tip of the nose) are pre-defined and identified on the Body mapping component 152, which are provided by the anatomical location database 402. Anatomical landmarks can mainly be used as a reference points when triangulating the location of a skin lesion via a triangulation component 406. Triangulation is a process in which three reference points on the patient's body are used to measure the distance to the lesion in question. These reference points may be pre-defined anatomical location and/or existing skin lesions (see next paragraph) on the patient's body. Thus, the triangulation process personalizes the generic Avatar 3-D Body Map, to a particular patient and his/hers intrinsic body measures.

In some cases, the pre-defined triangulation reference points are insufficient for the mapping of the lesions and an additional arbitrary point(s) may be identified on the body mapping component 152 and used for triangulation. These are arbitrary reference points on the patient body that include permanent skin lesion(s) and anatomical landmarks (e.g., Nipple). They are quick to choose and limited to only few common ones. Arbitrary reference point is referred to as Accessory Point.

Note: The distances of the lesions from the triangulation points are measured by a ruler on the patient's body and are entered into the body mapping component 152 (“located 3 cm from the nose tip, 2 cm from the left lateral canthus and 4.7 cm from the left tragus.”).

Providers is able to add/edit/delete problems on the Body mapping component 152, to view a list of active problems as well as historical problems and to zoom-in/out on specific regions.

Body Mapping Component 152 Views

Body mapping component 152 can support maps for both male and female bodies. One of the (internal) parameters for the Body mapping component 152 is which gender map to use (gender information which can drive this parameter is retrieved from the patient profile).

The system can provide a realistic full 3D view of body mapping component 152 with high quality textures. Users are able to rotate body model, move the camera in all four directions and to zoom in/out any part of the body. It is possible to rotate the model around Z-axis (left/right) and Y-axis (up/down), either by moving a mouse or clicking corresponding buttons of the anatomical locations on the form. In short, all of the body areas are visible and easily accessible via different views.

The system can provide different ways for rotating, moving and zooming in/out:

Via UI controls (i.e. buttons) on the form for: rotate left/right, up/down, move (left, right, up, down), zoom in/out

By moving the mouse and using the mouse scroll users is able to perform all necessary actions (i.e. when moving the mouse, camera can rotate around the model; if user holds left mouse button while moving the mouse, the camera can move the way mouse moves; mouse scroll can be used for zooming in/out)

In order to simplify positioning of the camera, which may be useful if user is using the mouse for positioning, users is able to disable rotation around one of these axes, or to disable moving the camera in one or more directions (i.e. if user is looking only the head, then he may want to disable rotate up/down and/or moving right/left/up/down—only rotate right/left and zoom in/out is available).

Additionally, there is predefined set of different camera positions for the whole body (A, P, R, L, 45° R, 45° L). It can also be possible to focus at a specific body part (e.g. feet, ears, hands, etc.).

Triangulation Component

In some cases it is very important to determine the exact location of the lesion (or biopsy site or treatment location). For this purposes, provider may use a triangulation component 406, which is an example of multiple skin lesions of same kind (moles) on the patient back. The provider may use three of these lesions to triangulate the dark brown lesion in the upper right area.

Triangulation is a process in which three reference points on the patient's body are used to measure the distance to the lesion in question. These reference points may be pre-defined anatomical location, or Accessory Points (existing skin lesions on the patient's body). The system can allow quick add of Accessory Point—user is able to choose one from the limited list containing only few common diagnoses. Selection of the AP's is added on the map in the “Benign” category and is added to Assessment with predefined text and ICD-9 and ICD-10, of course.

Triangulation Reference Points are displayed automatically whenever triangulation option is chosen. AP's, however, is entered only when Provider selects them.

Display Of Body Mapping Component Elements

The system is able to display Physical Exam (PEx) Findings (i.e., descriptive elaboration of the patient skin lesions), Problem, and Biopsy and Treatment sites on the Body mapping component 152. These sites is referred to as Body mapping component 152 Elements (BME). BMEs is displayed on the Body mapping component 152 using visual markers of different colors and shapes. Each category is displayed in a different shape (i.e. acne is small circle), and different colors are used to indicate problem status (i.e. active problems is displayed in red). On the form, there is a legend describing usage of colors and shapes, accessible via “Legend” button. If multiple problems and/or orders are present on the same location, then the system is able to display all of them (i.e. they are partly transparent, or displayed in different layers), Of course, there is a filter for each category, and the users are able to select what they wish to see on the model. By default, each new encounter can start with a blank Body mapping component 152 (i.e. without historical BMEs). Provider is allowed then to select which historical BMEs he wants to display. Historical BMEs can also be able to be filtered by the Date of Service (DOS).

One dermatologic problem can be present as a single lesion, involving one body part, but it may also be present as a set of multiple lesions distributed on different body areas or involving the entire body. For instance, acne can present as a single lesion, but may involve the entire face, neck, chest and back. In this case of multiple lesions of etiology (e.g., acne), the system should visually display all the lesions in the same manner (color and shape), and it should look different then the other problems, of different etiology (e.g., psoriasis).

Problems that have Triangulation information can show a small triangle superscript next to the problem marker (in addition, or instead of the dot/circle problem marker). Clicking on the triangle can highlight reference points (e.g. small/big effect) and display distance from the problem marker, on the body mapping component 152 to help Provider identify them on the patient's body.

A morphology component 404 provides a pre-populated listing of morphology descriptors to properly identify and describe observed patient conditions. Such information can be used to determine a proper diagnosis.

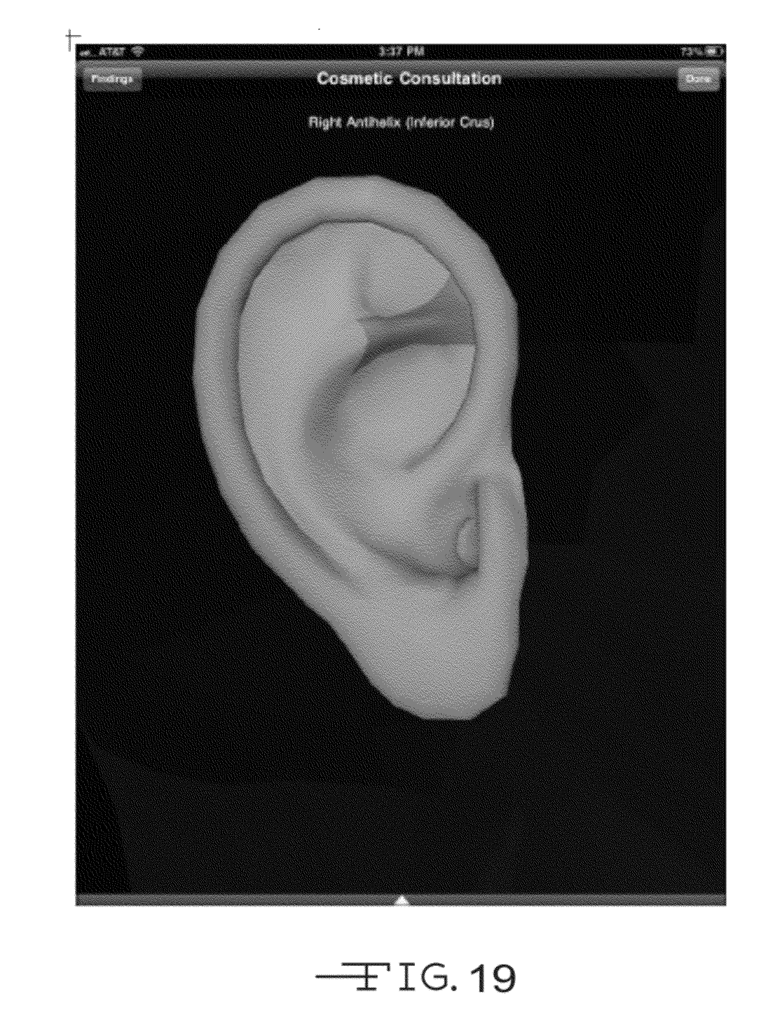

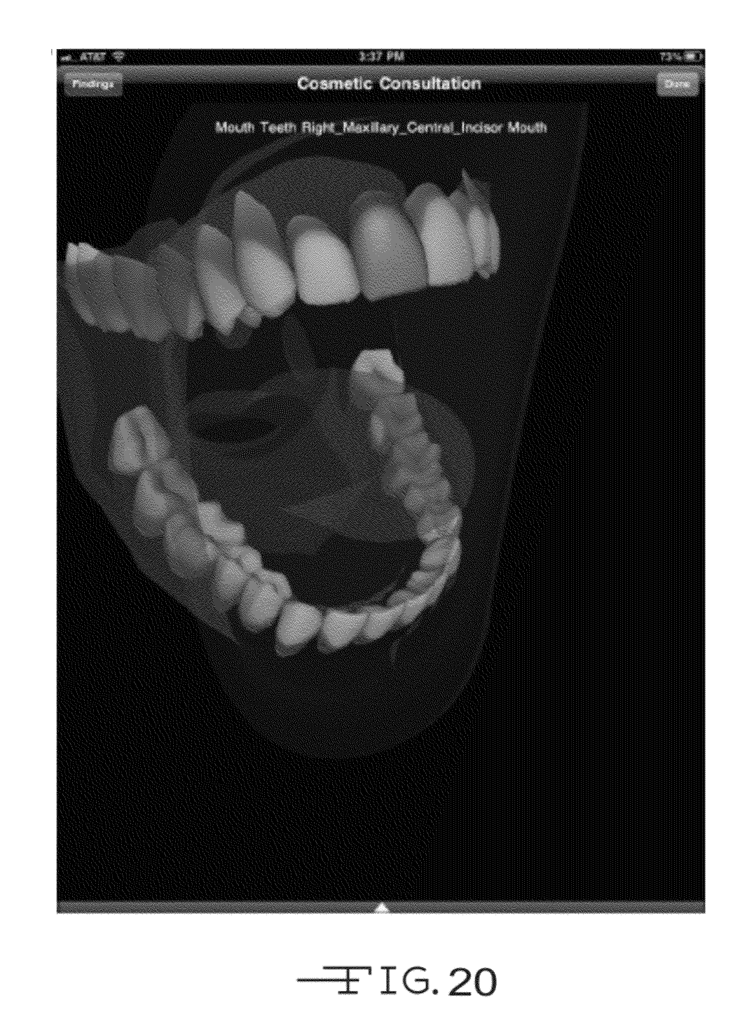

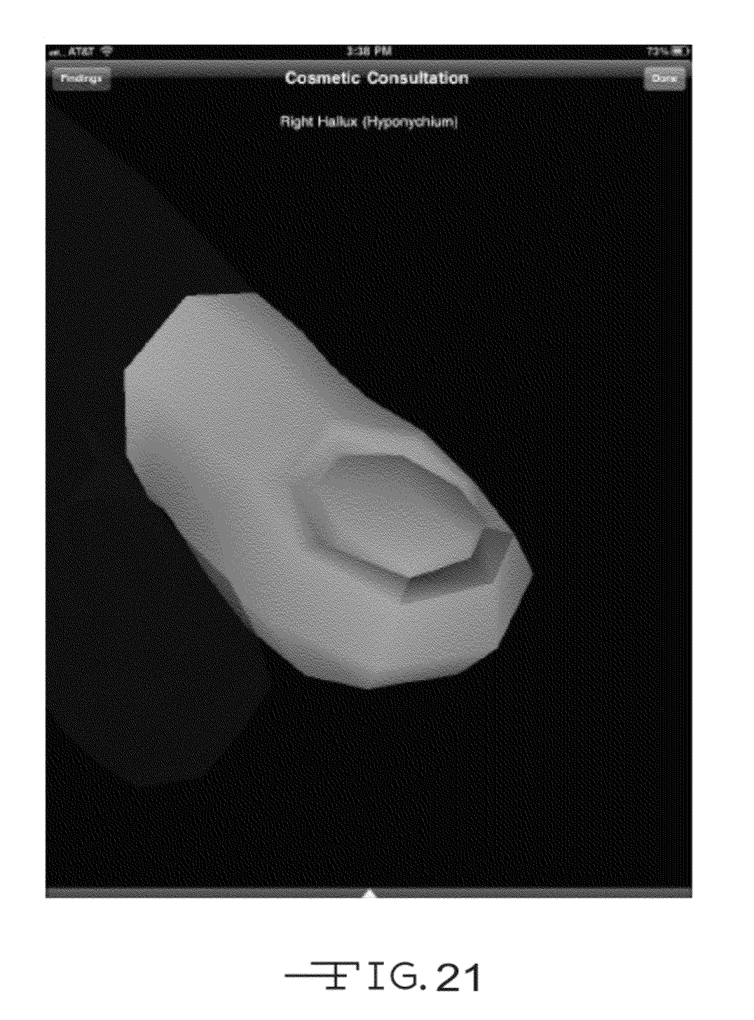

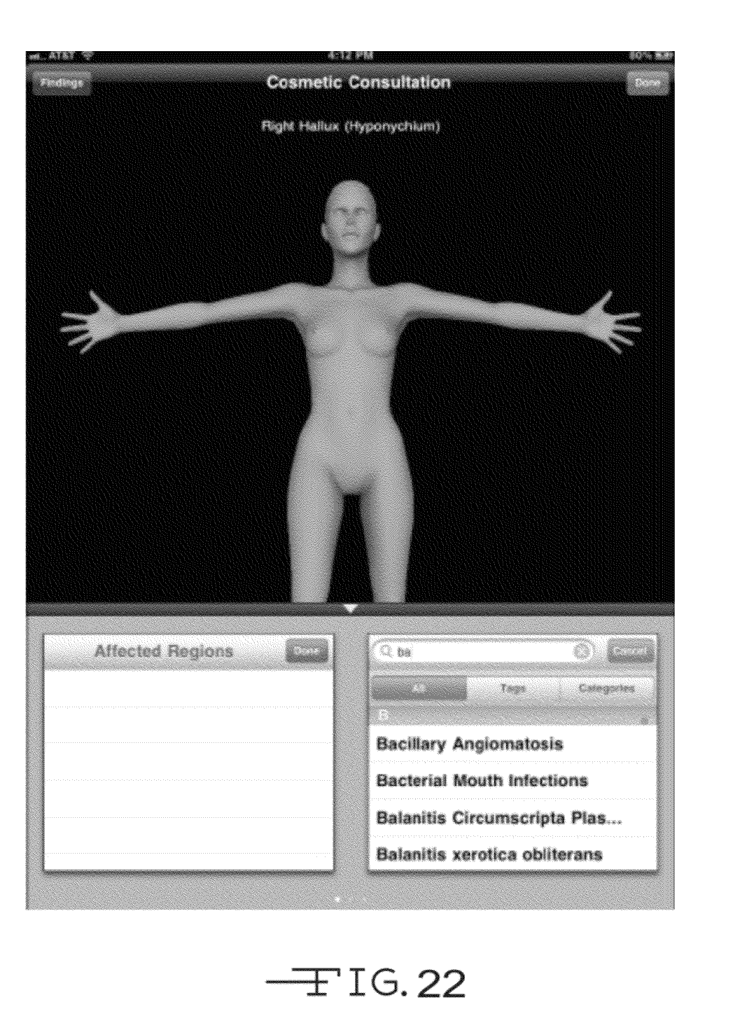

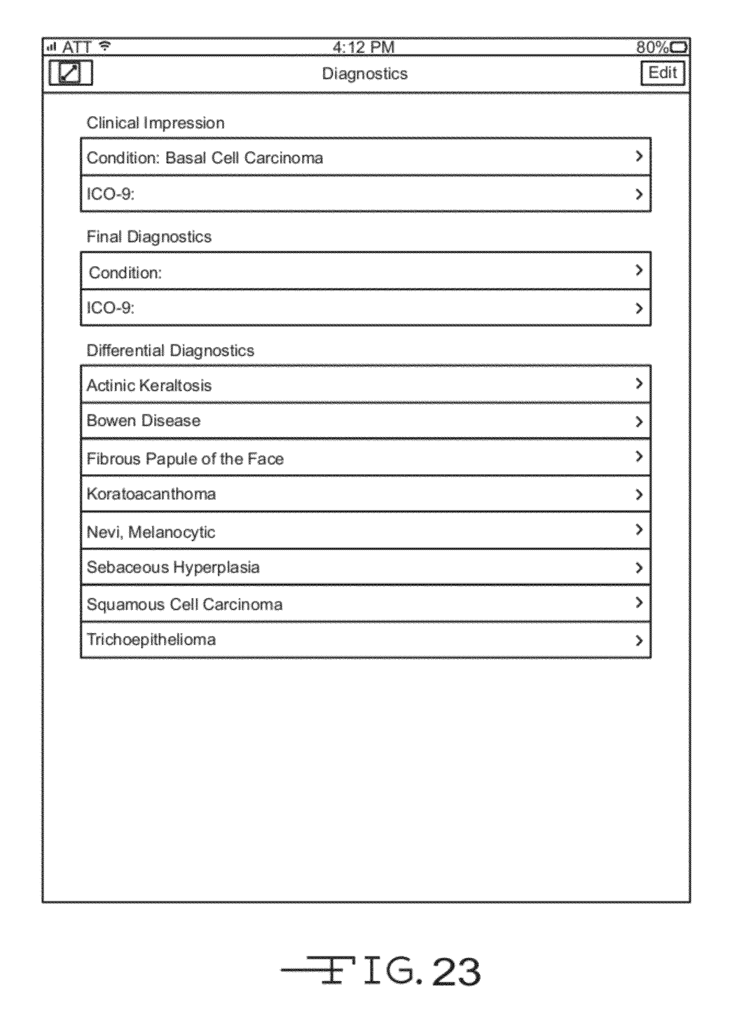

The body mapping component 152 can also include a zoom component to allow a user to graphically zoom to any location on the human anatomy. In one example, zoom functionality can be incremental to move from gross regions of the body down to specific zones. FIGS. 18-21 show various exemplary anatomy and zoom levels associated therewith.

A body position component 410 provides a human body in a characteristic position to allow easy identification and location of particular anatomical regions. For instance, axillae, perineum, and medial surfaces are all accessible and visible. The same are not visible in a conventional “Anatomic Position.” Moreover, a ghost mode component 412 can be employed for areas of the body that are not easily visible, wherein body parts that are not selected are transparent.

A biopsy-tracking component 414 is employed to insure that biopsy results are followed upon and appropriately addressed by a medical provider. Difficulty arises in those cases when multiple biopsies are taken on a patient. It is quintessential for the exact location and exact diagnosis to be known of the biopsy. The biopsy-tracking component can store and provide alerts and/or reminders that follow up is necessary in a timely manner. In addition, the MPS 100 can be connected to a Laboratory Information System via a computerized link in which the two systems interact and exchange information about specific patients. All of the relevant information can be entered about the biopsy specimen, including but not limited to Biopsy Specimen Number, Location (which is linked to the 3D map anatomical area), Date of Biopsy, Free Margin Involvement or Absence. Also information on what has been done with the biopsy site is documented, which may include but is not limited to excision, cryosurgery, curettage, etc. The biopsy tracking component 414 also tracks the total number of biopsies preformed on the patient, the number of not reviewed (biopsies that arrived to the system from an LIS, but have not been reviewed by the dermatologist), active (biopsies that have not been treated) and inactive biopsies (biopsied lesions that have been appropriately treated). The component can also differentiate the biopsy diagnoses into categories, including but not limited to Benign, Pre-Malignant, Malignant. The dates of the biopsies and their treatments are also kept in the database.

A cryosurgery/cryotherapy component 416 an be employed within the mapping component 152 to appropriately document a CPT code for the procedure of cryosurgery or cryotherapy. The component 416 can allow a medical provider to: 1. Select appropriate ICD-9 or ICD-10 Diagnostic Code (e.g., Actinic Keratosis); 2. Counts the number of skin lesions that is treated; 3. Based on the number of treated skin lesions, it assigns the appropriate CPT code as shown in the graphic below. For instance, if there is more than 15 lesions treated, a CPT code 17004 can be assigned; and 4. record not only the exact x,y,z coordinates, but also the anatomical location of the treatment site. This anatomical location can be further documented in the Physical Exam section of the Progress Note. in this manner, the component 416 allows for an accurate coding and documentation of the procedures performed by the medical provider.

Body Mapping Component Filters

Body mapping component 152 interface can support filtering by Date of Service (DOS), by Problems and by Biopsy Results, for selected patient. This can allow user to selectively display problems on patient's body mapping component 152 via a set of “show/hide” UI controls that can selectively display information on the Body mapping component 152.

DOS represents a date when the patient was examined (user can select one specific DOS from the list of prior visits to the Provider). When filtering by DOS, the system can display all Body mapping component 152 elements on the patient's body added during this specific encounter (on the DOS).

When filtering by Problems and Biopsy Results, the system can show only selected elements, regardless to the DOS (e.g. it can show all unresolved problems, or all malignant problems the patient had). Label for every UI control includes a number in parenthesis displaying the count of items it can show. By default, all filters is off, meaning that nothing is displayed on the Body mapping component 152. If certain filter does not contain any data for display, the corresponding button is hidden away. That is, only the diagnoses that contain data can show as the button. These filters can be divided into several groups: Problem Status, Problem Diagnosis and Biopsy Results:

Problem Status Filters (shows/hides unresolved problems)

Problem Diagnoses Filters (shows/hides locations on the body based on the diagnoses)

Benign—shows all problems with some benign diagnosis

Malignant—shows all problems with some malignant diagnosis

Dermatoses

Cicatrix

Ulcer

Biopsy Results

Pending Review—shows all orders with status equal to Pending (biopsies which are not done yet)

Inform—shows all reviewed orders that need to be explained to the patient

Pending Treatment—shows all biopsy diagnoses and biopsy results that have been reviewed, but their treatment has not been completed.

Managing Body Mapping Component 152 Elements

Via Body mapping component 152, users is able to add new BMEs (diagnoses, treatment and biopsy sites) and edit or remove existing. For existing BMEs, on the appropriate edit page (or if required available on the right click), system can also allow uploading images directly to the patient folder.

ICD-10 Component

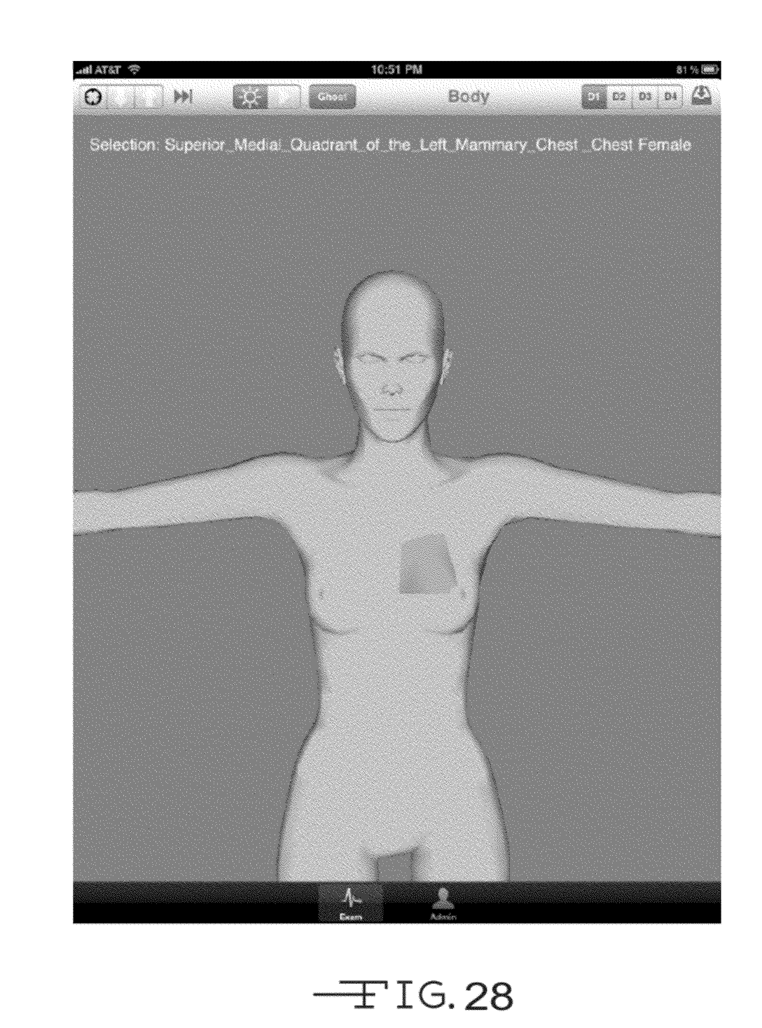

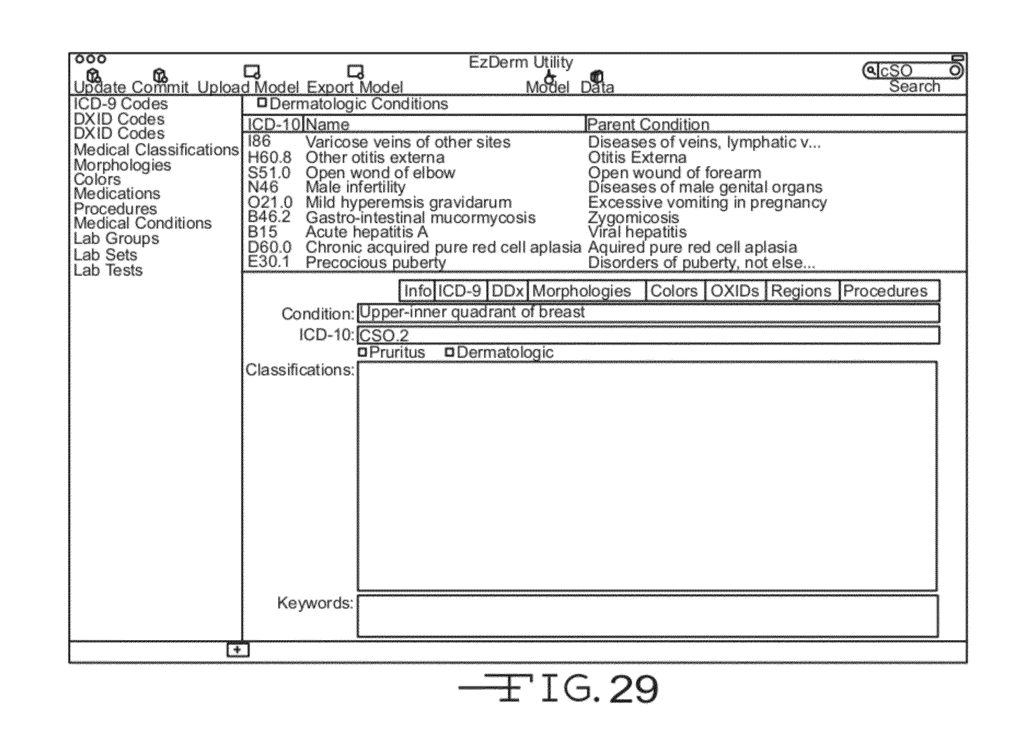

The international statistical classification of diseases and related health problems tenth revision (ICD-10) is a coding of diseases and signs and symptoms abnormal findings, complaints, social circumstances and external causes of injury as classified by the World Health Organization. The 3-D map in the system can provide over 2,000 regions of surface anatomy of the skin map than for each of these regions can be connected to a relevant ICD-10 code for example, ICD-10 code C50.212, is a malignant neoplasam of an upper inner quadrant of the left female breast. Such coding can be utilized when identifying conditions in particular anatomical regions, a set forth on FIGS. 28 and 29.

The MPS 100 provides appropriate ICD-10 coding for diagnoses at any location on the human anatomy via an ICD-10 component 418. For example, ICD-10 code C50,212, is related to a malignant neoplasm of upper-inner quadrant of left female breast. The location of this abnormality can be mapped, via the 3-dimensional portal, and how a diagnosis can be selected, via the clinical portal 150, based on the mapped location. In one example, a medical provider (or other medical profession) can use a touch screen to select the appropriate anatomical location and subsequently select a diagnosis from a list of ICD-9 or ICD-10 conditions.

ICD-10-CM is a clinical modification of the World Health Organization's ICD-10, which consists of a diagnostic system. ICD-10-CM includes the level of detail needed for morbidity classification and diagnostic specificity. It also provides code titles and language that complement accepted clinical practice. As with ICD-9-CM, ICD-10-CM is maintained by the National Center for Health Statistics.

The system consists of more than 68,000 codes, compared to approximately 13,000 ICD-9-CM codes. ICD-10-CM codes have the potential to reveal more about quality of care, so that data can be used in a more meaningful way to better understand complications, better design clinically robust algorithms, and better track the outcomes of care. ICD-10-CM incorporates greater specificity and clinical detail to provide information for clinical decision making and outcomes research.

ICD-10-CM Structure

ICD-10-CM has an index and tabular list similar to those of ICD-9-CM, However, the ICD-10-CM index is much longer. As with ICD-9-CM, ICD-10-CM uses an indented format for both the index and tabular list. Categories, subcategories, and codes are contained in the tabular list.

The two parts of the ICD-10-CM index are the index to diseases and injury and index to external causes of injury. The table of drugs and chemicals and the neoplasm table are housed in the index to diseases and injury.

The former V codes are now Z codes contained in chapter 21, “Factors Influencing Health Status and Contact with Health Services.”

Additional System Features

ICD-10-CM has numerous new features allowing for a greater level of specificity and clinical detail. These include:

Combination codes for conditions and common symptoms or manifestations

Combination codes for poisonings and external causes

Added laterality

Added extensions for episode of care

Expanded codes (injury, diabetes, alcohol/substance abuse, postoperative complications)

Inclusion of trimester in obstetrics codes and elimination of fifth digits for episode of care

Expanded detail relevant to ambulatory and managed care encounters

Changes in timeframes specified in certain codes

External cause codes no longer a supplementary classification

ICD-10-CM also includes added standard definitions for two types of excludes notes. The code being excluded is never used with the code. The two conditions cannot occur together. For example, B06 Rubella [German measles] has an Excludes1 of congenital rubella (P35.0).

Excludes2 indicates not included here. The excluded condition is not part of the condition represented by the code. It is acceptable to use both codes together if the patient has both conditions. For example, J04.0, Acute laryngitis has an Excludes2 of chronic laryngitis (J37.0).

An additional feature is the expansion of codes for certain conditions. Two examples are diabetes mellitus and postoperative complication codes.

Diabetes mellitus codes are expanded to include the classification of the diabetes and the manifestation. The category for diabetes mellitus has been updated to reflect the current clinical classification of diabetes and is no longer classified as controlled/uncontrolled:

E08.22, Diabetes mellitus due to an underlying condition with diabetic chronic kidney disease

E09.52, Drug or chemical induced diabetes mellitus with diabetic peripheral angiopathy with gangrene

E10.11, Type 1 diabetes mellitus with ketoacidosis with coma

E11.41, Type 2 diabetes mellitus with diabetic mononeuropathy

ICD-10-CM provides 50 different codes for “complications of foreign body accidently left in body following a procedure,” compared to only one code in ICD-9-CM. Examples include:

T81.535, Perforation due to foreign body accidently left in body following heart catheterization

T81.530, Perforation due to foreign body accidently left in body following surgical operation

T81.524, Obstruction due to foreign body accidently left in body following endoscopic examination

T81.516, Adhesions due to foreign body accidently left in body following aspiration, puncture or other catheterization.

CPT Integration Component

American Medical Association maintains the CPT code set through the CPT editorial panel. The CPT code said accurately describes medical, surgical, and diagnostic services and is designed to communicate uniform information about medical services and procedures among medical providers, coder, patients, accreditation organizations, payers for administrative, financial, and analytical purposes. In one embodiment, the 3-D body mapping component 152 is connected to corresponding CPT codes via a CPT integration component 420. For instance, an anatomical location can be linked to the CPT codes for various procedures and/or treatments administered to a patient. Such CPT codes can be exported to the billing portal 170 (or other location) to allow seamless interface between treatment and billing within a medical practice.

Body Surface Area Component

Individual variability of a patient's body surface area (BSA) is calculated by a body surface area component 422 based on their body mass index, wherein BMI equals units of weight divided by units of length squared. The medical provider inputs distribution of a skin condition as described above. The surface of the 3-D model, after adjustment for the BMI variability, is set at 100% of BSA. BSA involvement by a skin condition is then calculated as (BSA involved with his skin condition divided by total BSA). The BSA component 422 analyzes the input and calculates the BSA as a percentage of the body affected by a skin condition.

PASI (Psoriasis Area Severity Index) Scoring Component

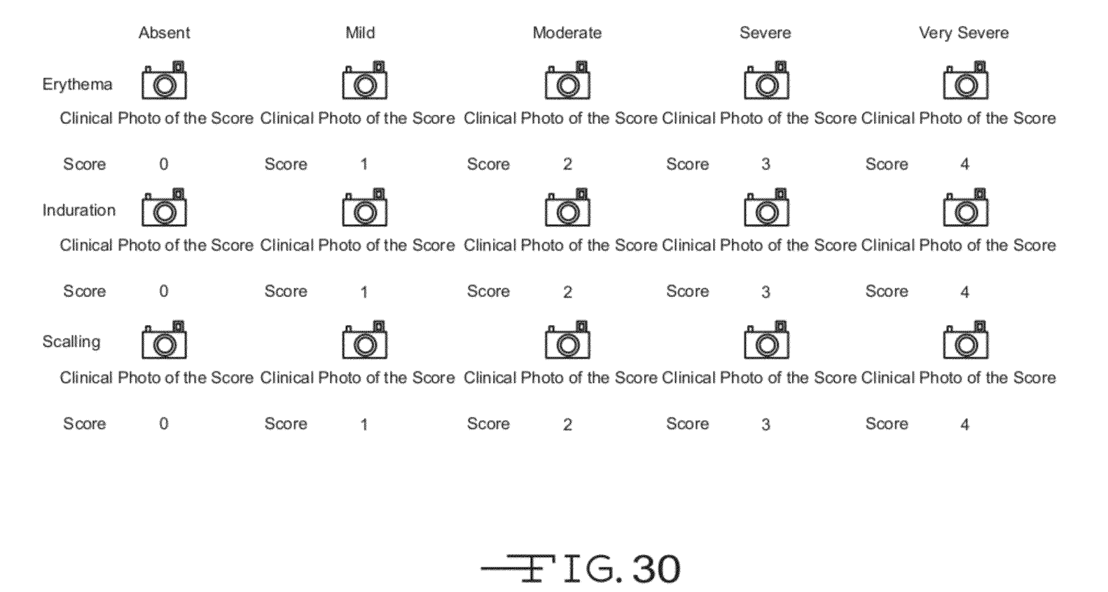

A PASI scoring component 424 provides users with a tool to objectively evaluate and calculate PASI scores, which is an objective tool that utilizes standardized references in order to produce consistently uniform results, in order to provide consistent diagnosis the following steps can be employed, as provided in FIG. 29. First, a BSA is calculated as described above using the 3-D model. A PASI score is BSA as traditionally dividing the body into four areas (head, trunk, upper extremities, lower extremities), Each of these areas is assigned a fraction (or percentage) of the surface area of entire body with an assumption that the patients palm has a surface area of 1%. For instance, head is approximately the equivalent of the surface area of 10 palms and hints that the accounts for 10% of PSA. In place of this conventional calculation, the PASI score component 424 provides a more accurate result as it takes into account the patients BMI and the area calculated by based the 3-D algorithm and not via a “palm method” approximation. Erythema, Induration, and Scaling Grading are employed by the PASI score component 424 to provide a standardized graphic user interface 110 such that the medical provider can compare the erythema, induration, and scaling standardized pictures to those of a subject patient. The medical provider selects a picture out of each of these categories (erythema, induration, and scaling) from FIG. 30 and the PASI score component records the score values and uses these along with the BSA to calculate a score for a patient.

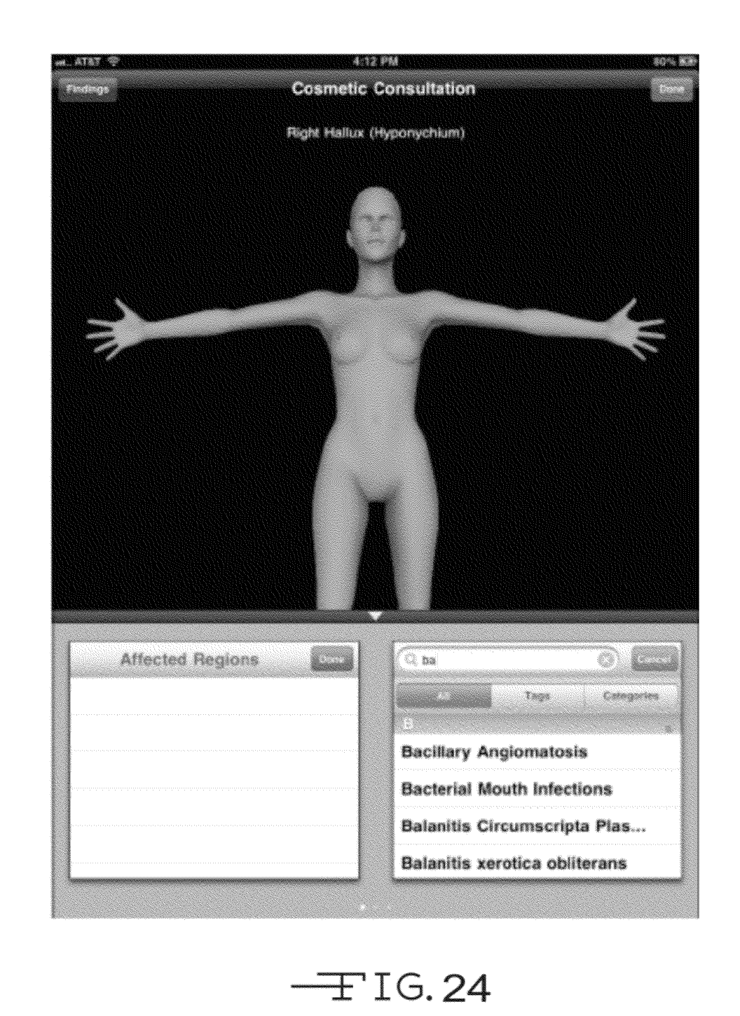

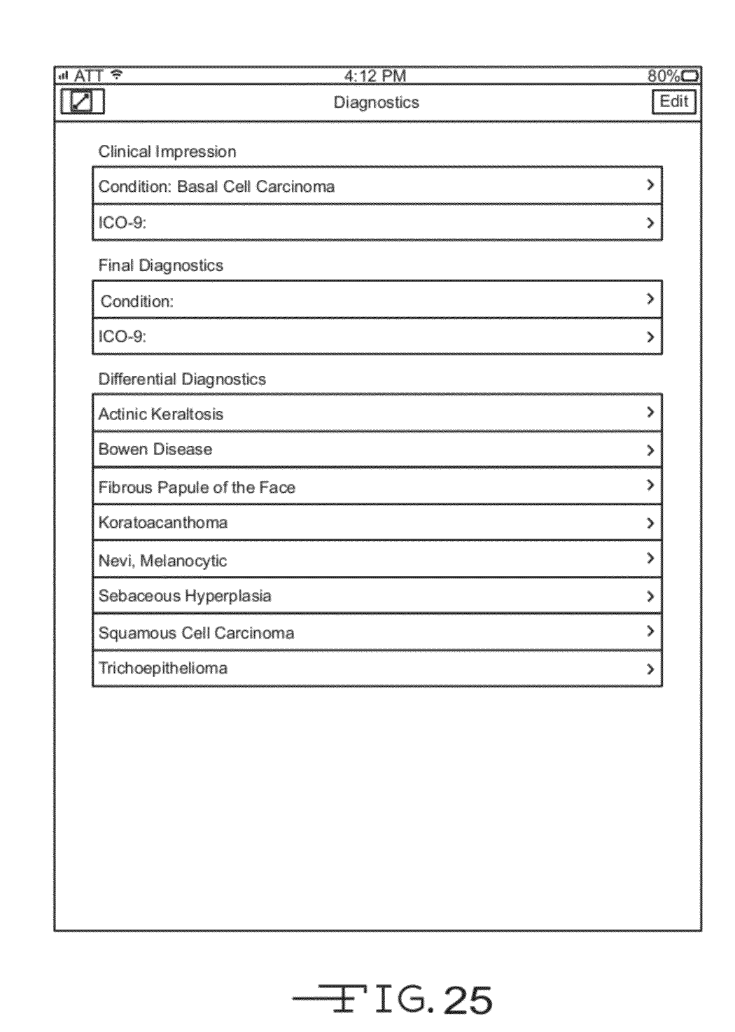

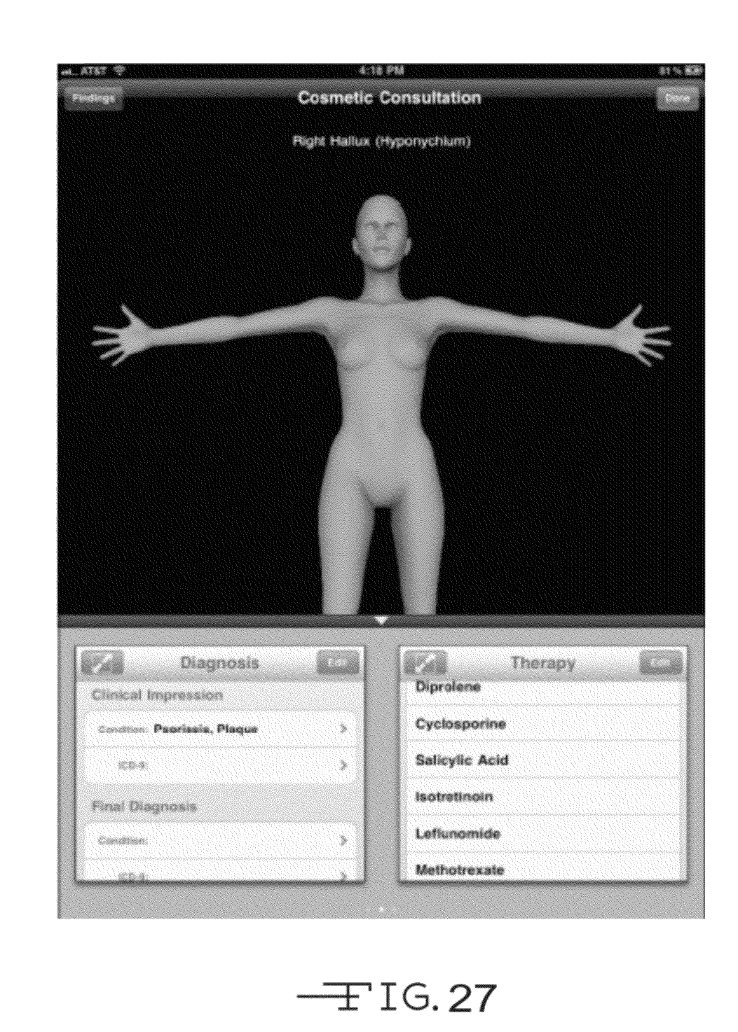

A key feature to the MPS 100 is the ability to present a 3-dimensional rendering of the human anatomy in concert with observational recording, diagnosis, treatment and coding. FIGS. 24-27 are illustrative of the use of the mapping component 152 with the diagnostic component 156 and treatment component 160.

The diagnostic component 156 can use a symptomology presentation and/or morphology presentation to generate differential diagnoses for a set of given patient conditions. A system entry component 512 aggregates answers from a patient (e.g., such as the patient portal 130), input from the medical provider during the interview, and firsthand examination of the patient. Input can be done in part using a 3-D map via the user interface 110. For each condition, lists of likely differential diagnoses can be generated by a symptom analysis component 510 to aid the medical provider to use relevant medical knowledge and clinical observations to arrive at a correct diagnosis. This information is then transmitted a symptomology presentation component 504 and a morphology presentation component 506.

Using the symptomology presentation component 504, a diagnostic list is generated based on a reported symptomology. For instance, if a patient presents with a rash, an algorithmic questionnaire can be generated that consists of a series of relevant questions relating to this complaint. One question can be whether a patient perceives the condition as itchy. If so, the system can generate a list of potential dermatologic diagnosis that may present with a rash and pruritus (a medical term for itching). The system can also take into account the age of the patient, gender, ethnic background, etc, as these parameters may rank different causes of the rashes differently.

Below is an example of a pruritic skin condition sorted by disease category.
Pruritus
   Infestations
      Scabies
      Pediculosis
   Inflammation
      Atopic dermatitis
      Urticaria
      Psoriasis
      Prurigo Nodulairis
      Aquagenic Pruritus
   Infection
      Bacterial infection
      Fungal infections
   Miscellaneous
      Lichen Ruber Moniliformis
   Neoplastic
      Cutaneous T-Cell Lymphoma
   Genetic/Nevoid
      Inflammatory linear verruclus epidermal nevus (ILVEN)
      Darier disease
      Hailey-Hailey Disease
   Others
      Pruritus in pregnancy
      Pharmcologic pritus
      Psychogenic pritus
      Xerosis
      Senile pruritus
      Anogenital pruritus
      Notalgia paresthetica
      Primary cutaneous Amyloidosis
      Post burn and post stroke pruritus
      Itching in scars
      Fiber glass dermatitis
      Aquagenic pruritus

As an alternative or in addition to the symptomology presentation component 504, the morphology presentation component 506 can be employed to generate a list of differential diagnoses based on symptoms, signs, anatomical locations, color, morphology, and distribution of skin findings. Some dermatologic conditions are site specific. The component 506 can employ a database which has diagnosis associated with different anatomical locations therein which have a greater number of matching criteria ranked higher in the differential list. For instance, a yellow color change of the nails may be associated with the following findings: colon bronchiectasis, immunodeficiency, lymphedema, nephritic syndrome, nicotine stain, onychomycosis, pleural effusion, Raynaud's disease, rheumatoid arthritis, sinusitis, thyroiditis, and tuberculosis.

On the other hand, if the patient is a child and has a fever (detected if the input in the Body Temperature part of the vital signs is equal to or greater 100° F.), the differential diagnosis may contain a list of the following diagnoses: Juvenile Idiopathic Arthritis, Acute Systemic Lupus Erythematosus, Dermatomyositis, Roseola, Measles, Enterovirus, Fifth Disease, Vasculitis, Serum Sickness, Rocky Mountain Fever, etc. If a medical provider selects a primary morphology to be papule, the system can provide a list of conditions that may cause a papule, including:

Acne, Atopic dermatitis, Cat-scratch disease, Cherry angioma, Cholinergic urticaria, Chondrodermatitis helicis, Eczema, Folliculitis, Arthropod bites, Keratosis pilaris, Leukocytoclastic vasculitis, Miliaria, Polymorphic light eruption, Psoriasis, Pyogenic granuloma, Scabies, Urticaria, Angiokeratoma, Blue nevus, Lichen planus, Lymphoma, Kaposi's sarcoma, Melanoma, Mycosis fungoides, or Venous lake.

If provider selects the color of the papule to be pink and/or red, the list of differential diagnoses is reduced to: Acne, Atopic dermatitis, Cat-scratch disease, Cherry angioma, Cholinergic urticaria, Chondrodermatitis helicis, Eczema, Folliculitis, Arthropod bites, Keratosis pilaris, Leukocytoclastic vasculitis, Miliaria, Polymorphic light eruption, Psoriasis, Pyogenic granuloma, Scabies, or Urticaria

If a secondary morphology of the scale is selected, then the list is limited to: Acne, Atopic dermatitis, Cat-scratch disease, Cherry angioma, Cholinergic urticaria, Chondrodermatitis helicis, Eczema, Keratosis pilaris, Polymorphic light eruption, or Psoriasis.

If the location of a pink and/or red papule is limited to knees, and elbows, then Psoriasis is ranked higher than any of the above diagnoses.

If the location is the nose tip, then the following may be in the differential diagnoses: Acne, Folliculitis, Arthropod bites, Urticaria

If the acne is selected as the appropriate condition by the provider, a list of the differential diagnoses for the acne is given.

Clinical Portal 150 (CP)

Clinical portal 150 is a web-application used by providers, Clinical staff, and administrative staff employed at a Practice/Clinic to manage day-to-day operation of the dermatology Practice. Each user of the system includes access to the pages that can provide a role-centric way to complete necessary information in an efficient and logical way.

A basic workflow of the information through the Clinical portal 150 is as follows:

Patient schedules an appointment (Front Office staff can use Clinical portal 150 to schedule appropriate time for the visit and to obtain basic information from the patient)

Patient Completes His/Her Profile Information Through the Patient Portal 130

Patient comes to the Clinic. Front-office staff (Front Office) obtains necessary demographics/insurance information from the patient—if it was not completed by the patient via the Patient portal 130 prior to the visit (or reviews it, if it was provided via Patient portal 130). For established patients, information is reviewed and updated if needed. Patient signs-in (a paper form or electronically). Relevant docs (insurance card, id) are scanned/uploaded to the system.

Patient is brought to the examination room. Clinical staff (Mid Office) takes vital signs and enters them into the system. Clinical staff takes (or confirms info entered via Patient portal 130) information for Allergies, Medications, and Past Medical History with the patient. Clinical staff determines the patient's Complaints (including Chief Complaint) and History of Present Illness (for each Complaint) or reviews information entered by the Patient via Patient portal 130.

Clinical Staff performs Review of Systems, if it was not entered by the patient via the Patient portal 130.

Provider greets the patient and reviews all the Clinical information, edits any discrepancies, and/or adds necessary information.

Provider documents the skin examination findings using the Body mapping component 152.

Provider formulates the Assessment for the visit.

Provider formulates the Plan for the visit (e.g. diagnostic procedures or treatments).

Provider determines the need for the follow-up appointment and suggests when (e.g. follow-up in two weeks) the follow-up appointment should take place.

Provider explains to the Patient the Clinical impression, what he plans to do, prescription/biopsy site case instruction (if necessary) are given to the patient.

Provider ensures that billing codes for this visit are entered properly. The billing code algorithm of the system automatically calculates most of the billing codes.

Patient goes to the front office to check out. Front Office obtains the payment for the visit and schedules the follow up appointment (if needed) with the patient. Alternatively, some offices require the patients to make payment(s) prior to the visit itself. Patient is given educational materials and/or prescription(s).

Patient is scheduled for the follow-up appointment, based on the Provider's recommendations.

Patient leaves the office.

The system generates a “Thank You” email that also contains an evaluation survey of the visit.

The system generates reminder(s) prior to the follow-up visit.

Administrative staff processes the claim with the insurance company.

Clinical portal 150 also consists of the following modules: Scheduler/Calendar, Patient Medical Record, Accounting, and Settings. System can also support searching capability and provide various reports.

Software Administration

Software Administration module allows Practices to customize some portions of the Clinical portal 150 to their needs. Following are exemplary types of information that are customizable for each Practice via a Settings module:

General Information

System Preferences

Clinics (General info, Resources, Scheduling, Visit Types, Laboratories, Diagnostic Imaging Laboratories)

Users

Referring Medical providers

Only users with a Software Administrator role can access to these pages.

Clinic Management

Clinics represent different locations for the Practice; they are not completely separate business entities from the accounting/billing perspective. Each Practice can have more than one location (i.e., Clinic) at which it accepts patients. The system can provide an existing list of Clinics to a user and allow users to add/edit/disable Clinics.

List Clinics

The system can present a list of existing Clinics in the system in a tabular manner. Following attributes can be displayed: Clinic Name, Address, Phone, Fax, E-Mail address and Website.

Clicking on the Clinic name can open Clinic page. This page can also have Add New Clinic button that can allow a Software Administrator to add new Clinics to the system.

Note: each Practice can always have at least one Clinic.

Add/Edit Clinic

Adding and Editing Clinic are essentially the same operations from the user experience and the UI perspective.

Clinic information contains two sections: general and billing, General information includes following attributes:

Name

Contact Information: Street Address, City, State, Zip, Phone, Fax, Mail and Website

Primary Clinic Flag (only one Clinic in the practice can be primary)

Time zone (allowing selection of one time zone from the list of US-only time zones, the system should default to the user's time zone)

Notes/Description

Examination Rooms (comma-separated list of room numbers that exist in the Clinic)

Providers and support staff can use data from general information section internally within the practice.

On the other hand, billing information is supposed to be used in forms which administrative staff can send to insurance companies. It should contain some of the attributes from the general information section. However, these attributes don't necessarily need to have the same values as in general information section.

Following exemplary attributes that may be presented in billing section:

Name

Contact Information: Street Address, City, State, Zip, Phone, Fax and E-Mail

Primary Clinic Flag—only one Clinic in the practice can be primary

Federal Tax ID

Check Payable To

Bank Account

CLIA ID Number

Taxonomy Code

Group NPI Number

Place of Service Code

The system cannot allow creation of Clinic that has the same name or address as another Clinic in the system (belonging to the same Practice).

For each Clinic, users can manage Resources, Visit Types, In-House tests, Laboratories, and Diagnostic Imaging Laboratories for Clinics.

Resource Management

Resources can be defined on a system (Practice) level. Each Practice includes a set of resources (medical equipment) that are used for a specific procedure (e.g. laser), wherein users are able to add and/or remove resource. Users are presented with a list of resources available in the entire practice in a tabular manner with Resource Name and Count (number of specific resources, since there could be more than one resource of a specific type). Users are able to add resources by specifying one or more of the following attributes: Name, Description, and Count. Name and Count Parameters can be mandatory. Count needs to be greater than 0. The system can check if a specified resource already exists in the system; if so, it can notify the user and allow him/her to update the count for the resource (if needed). From the user experience and the UI perspective, editing Resources is essentially the same operation as adding.

System can provide the way to schedule resources for appointment, at specified time and in specified Clinic. Since resource is defined on a Practice level, one would have to take this into consideration when scheduling (reserving) the resource. Restrictions can also be associated with a resource to limit availability to a particular Clinic, for a CT machine or other immovable resource.

This information is used to help staff not to overbook a resource when scheduling appointments, i.e. to prevent them from scheduling more appointments than available resources in a given time period.

When removing the resource, system has to check if there are appointments with the specific resource already scheduled at one or more times in the future. If this is the case, then system can warn the user about his action and/or prevent reservation of this resource at those times.

Visit Type Management

Visit Type is an optional attribute of the appointment that defines the type of the visit, and is used to preselect (suggest) values for some other appointment attributes, such as duration, required resources and service. When scheduling a new appointment, if Visit Type attribute is selected, then service, duration and required resources for the appointment is automatically copied from the Visit Type.

EzDerm can come with the predefined set of Visit Types, but each Clinic is able to customize/edit the Visit Types to accommodate to their mode of operations.

For each Visit Type, the system can track the following attributes:

Name

Default Visit Duration (in minutes)

Required Resources

Service (Consult Visit or EM Visit)

Name and Type attributes can be made mandatory; Default Visit Duration attribute can be optional and, if specified, it is used during the scheduling process to pre-set duration of the visit. In addition, if one or more Resources are needed for the visit, they can need to be specified by assigning them to the Visit Type (only resources setup in the system under Resource Management for can be assigned as required resources for the Visit Types).

Example of predefined Visit Types include: Consult, Cosmetic Consult, Established Patient, New Patient, Follow up, Surgery, etc.

Laboratories Management

The MPS 100 can include a list of laboratories in the United States and can also obtain a list, from these labs, as to which Insurance Companies are used by the LMs.

Via Laboratory Management pages, users are able to manage a list of labs that collaborate with the Clinic. List of Laboratories specified via these pages is presented to the Provider when specifying Lab tests. In addition, users are able to specify which laboratory tests are done in-house, via a In-House Laboratory Tests page.

Laboratory can be either a dermatopathology laboratory or a pathology laboratory.

List of Laboratories

This page can present a list of Laboratories that are tied with the Clinic. Following attributes can be displayed for each Laboratory: Name, Contact Person, Phone, E-Mail and Website. Clicking on the Name attribute can take users to the Edit Laboratory page. This list can be sorted by the Laboratory Name.

Add/Edit Laboratory

Following are the attributes that can be specified for the Laboratory:

Federal Tax ID

Name

Contact Person

Address

Phone

Fax

Email

Website

Participating Insurance Companies

Laboratory Type (dermatopathology or pathology)

The system can also prevent allow users to add duplicate Laboratories (i.e. having the same Name or Federal Tax ID).

Each laboratory has a contract with certain Medical Insurance Companies. The MPS 100 can provide contact information for each laboratory and enter a list of Insurance Companies associated with each laboratory. From this information, The MPS 100 can also filter which labs participate in the patient's medical insurance plan. These labs are then displayed as possible options for the provider to choose to which laboratory to send a particular specimen in question.

Diagnostic Imaging Centers Management

Logic for tracking for the DI Centers is the same as defined above for the regular Laboratories.

Drug Database Management

A list of medications that are used by the System can be provided via a third party drug database (www.firstdatabank.com). This vendor can also provide an API for medication management, to speed up the programming process. In addition to the data coming from the FDB, additional medications may be added either by the administrators or providers.

Following attributes can be tracked for each medication: Status, Name, Form, Strength, Take, Frequency, Dispense Quantity, Refills, Sig, Start Date, End Date, Modify Date, Renewal Date and the List of Tags.

Each medication includes the optional list of tags. Tags can serve to easily link the medications to other attributes, and is used for search purposes. For instance, if a dermatologist wants to treat diagnosis “psoriasis” The MPS 100 can search all medications with the tag “psoriasis” for filtration of medications used for the treatment of psoriasis.

Providers can able to extend the medication list with their own (custom) medications. This can include the option to add custom medications during the encounter with the patient (this is discussed later, in section; Error! Reference source not found.).

The system can also allow users with a Software Administrator role to add new medications, to change attributes for the added medications, as well as to delete medications, using the interface for Drug Database Management. Medications added this way is related to the entire practice, and is kept in local data source (separate from FDB).

Additionally, The MPS 100 may provide the list of medications prior to the delivery of the software to the client, or in a form of software update (this cannot be available in Version 1.0).

The system can provide the ability to exclude a medication from the current medication list (set Status to inactive) and document reason for such action.

Insurance Companies Management

The system can allow user to add new insurance company, to list, edit and delete existing. Information about Insurance Companies is organized into different sections (i.e. tabs on the UI), and each section includes different attributes. Below is the list of sections and attributes which is used:

General

Name

Submission Type (paper or electronic)

Representative Offices (see below)

Provider Numbers (list)

Electronic Submission Info

Source of Payment Code (select one record from the list of available codes and descriptions)

Insurance Type Code (select one record from the list of available codes and descriptions)

Payor ID (used for electronic submission only)

Medigap ID (used for electronic submission only)

ERA Payor ID (used for electronic submission only)

Managed Care Plan ID (used for electronic submission only)

Eligibility Payer ID (used for electronic submission only)

Insurance Claim Settings (first few are text inputs, others are checkboxes)

Claim Office Number (text input)

Claim Office ID Type (text input)

HCFA Box 19 (text input, applies only to paper forms)

Requires Referral

ANSI Payer

Electronic Claims Production Status Enabled

Send Fractional Service Units

Requires UPIN in EA0-21

Send Secondary Claims Electronic

Enable Referral Number in Referrals/Claim Insurances

Print Supervising Provider Number in HCFA Box 22

Electronic Claims—Submit Only the start date when the start and end dates are same for a procedure

Electronic Claims—Don't Send Service Facility Information for Place of Service (POS) Code 11

HCFA Box 32—Don't Send Service Facility Information for Place of Service (POS) Code 11

Do not include Payments/Adjustments in Patient Statements

Accept Assignment (HCFA BOX 27)

Do Not Print HCFA 29

Do Not Print HCFA 30

Send NPI Numbers in Electronic Claims

Send Legacy Numbers in Electric Claims

Print NPI Numbers

Print Legacy Numbers

Print EPSDT Referral Code in HCFA 24C

Send Group No in 2310b loop segment

Send OTAF Segment for Secondary

Free Text Note(s)

For each representative office, the system can keep track of following:

City

State

Street Address 1

Street Address 2

Two Phone Numbers

Fax Number

E-mail

Website

Provider Numbers list can contain multiple entries, each containing following:

Provider Name (a drop-down or similar is used for this)

Provider Number

Provider ID Type

Group Number

Group ID Type

Effective Date

It is required to have multiple representative offices because one insurance company can have multiple locations with different addresses. In patient medical record, there is link not only to the company record, but also to one of the representative offices, because administrative staff can need to know the exact address where to send insurance claims. Insurance Claim Settings can be used when generating insurance claims, both paper and electronic.

User Management

The system can allow users with the a Software Administrator role to list and search Clinical portal 150 users, to add new users, edit existing users and to disable users.

List/Search Users

The system can present a list of existing users in the system in a tabular manner. Following attributes are displayed in the system: First and last name, Email, Phones (a list of phones, each one prefixed with “C:” [Cell] “H:” [Home] “W:” [Work] to indicate the type of the phone), Roles (a list of user roles; acronyms can be used instead of full names for the roles), and the last login time. Users whose accounts have been disabled are displayed with strikethrough font to indicate they are not active users.

This page can provide a way to filter users which are being displayed (their names would be searched) as well as with the option to display disabled users.

Clicking on the user name can open user profile page.

This page can also have an “Add New User” button which can allow users to add new user to the system.

Add/Edit Users

Adding and editing a user are essentially the same operations from the user experience and UI perspective. Following user attributes is presented on the user profile page:

First name

Last name

Password (hidden field)

Contact Information: Email address, Skype ID, Work Phone, Cell Phone, Home Phone, Home Address

Date of Birth

Social Security Number (optional)

Role (one or more system roles)

NPI (this field can effectively be used only for Medical providers, so it are an optional field)

Supervising Medical provider (this field can effectively be used only for Medical provider Assistants, so it are an optional field)

Primary Clinic

Duties (free-text, comma separated list of duties this person performs)

Scanned Signature (optional; JPG with scanned providers signature)

Validation: the system cannot allow creation of new user who has the same email address as another user in the system (belonging to the same Practice).

The system can also allow document management and Working Hours management for the users.

Disable Users

Edit page can contain Disable User checkbox which can effectively disable user's account and their access to the Clinical portal 150. User accounts can never be deleted from the system but if their account is disabled they cannot be able to access the system. Via audit log it should track who disabled the account.

User Roles

Clinical portal 150 users is assigned one or more roles that can determine what type of functionality they can access in the Clinical portal 150. In the initial system, role permissions can be hardcoded.

Following user roles can be used in the Clinical portal 150:

Medical Provider (MD, DO, LPN, and PA)

Other Provider (Aesthetician, Laser Technician)

Support Staff (Front Office and Clinical Staff)

Biller

Software Administrator

Practice Management

Both Medical Provider and Other Provider review all of the Clinical information, perform and documents examination. However, there is some differences in permissions for these roles. For instance, only Medical Provider can prescribe a medication or schedule a non-billable appointment.

Support Staff role can be used for Front Office Staff or Clinical Staff.

Front Office Staff is usually assigned to phone answering, collecting general patient information and scheduling.

Clinical Staff reviews info entered by the patient on PP, confirms allergies, medications and past medication, adds missing information, etc.

Note: Providers and Support Staff may work in multiple Clinics, and in this case, upon successful login provider includes to choose the practice/Clinic.

Biller ensures timely payment from insurance companies and patients. For billing purposes, they are able to access patient medical information in order to properly bill.

Prior to the appointment the system send a confirmation email and an SMS message, allowing patient to confirm the appointment

If patient doesn't confirm the appointment by specific time, staff can call the patient and either confirm the appointment or cancel/reschedule it

Review/Modify Necessary Information

Ideally, the patient would provide all necessary information for the encounter via Patient portal 130. However, a patient is not obligated to do so, and in this case Clinical Staff and/or Provider would have to review/obtain necessary information.

Prior to the encounter, patient includes to decide whether he wants full body exam or not. This information is written to the database, and is displayed to the provider during the exam.

Physical Examination

The Physical Examination (PEx) represents an objective documentation of Clinical signs that the patient has. This includes skin examination and examination of the different organ systems, especially ones that might directly be responsible for the symptoms which the patient is experiencing. As a result of physical examination, provider is able to enter (objective) findings and measurements of the patient's skin (and/or other organ) status via the Body mapping component 152. For instance, if a patient has a black dot on the left cheek, the MPS 100 can auto-generate the following text: Left Cheek with 0.1×0.1 cm black macule located 3 cm from the nose tip, 2 cm from the left lateral canthus and 4.7 cm from the left tragus.

Note that physical exam does not include making a medical diagnosis (this can formally be done later, in Assessment).

During Physical Examination provider is able to note his/her observations of the patient. For each complaint, provider can:

Identify the body part of the problem on patient's body (“Left Cheek” from the above example)

May document the size of the lesion. (“0.1×0.1 cm” from the example above)

May triangulate the lesion (Triangulation is a process in which three reference points on the patient's body are used to measure the distance to the lesion in question. These reference points may be pre-defined anatomical location and/or existing skin lesions on the patient's body). (“Located 3 cm from the nose tip, 2 cm from the left lateral canthus and 4.7 cm from the left tragus.”)

Identify the Clinical Description (“black macule”)

Clinical Description results in the textual description of the patient's skin finding that is recorded in the patient's Physical Exam section of the Clinical note. This text can contain multiple attributes that is presented in the following order:

Bilateralism|Location|Multiplicity|Distribution|Symmetry|Color|Texture|Pigmentation|Odor|Shape|1° Morphology|2° Morphology|Border|Surface|Discharge|Modifiers|Signs

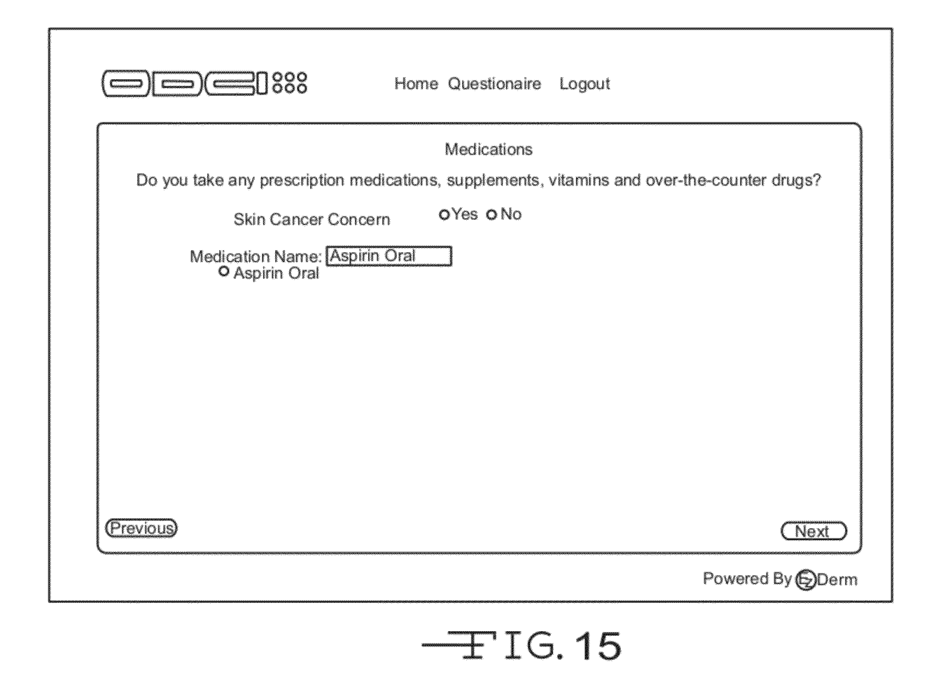

Note: The following semantics are used the text below: Color is a group of attributes and Pink is an attribute. A proposed GUI for toggled selection of these parameters is shown in FIG. 15B to show clinical description of PEx.

An example of the textual description of the patient's findings generated by this method:

Bilateral (Bilateralism) upper arms (Location): multiple (Multiplicity), scattered (Distribution), asymmetric (Symmetry), pink (Color), rough (Texture), hyperpigmented (Pigmentation), malodorous (Odor), polycyclic and round (Shape), hypertrophic, oozing, tender (Modifiers), plaques (1° Morphology), with excoriation (2° Morhology), irregular border (Border), cobbled surface (Surface) purulent discharge (Discharge) with positive Auspitz Sign (Sign).

Note: Multiple elements of a single group can be used (e.g., polycyclic and round (Shape), hypertrophic, oozing, tender (Modifiers)).

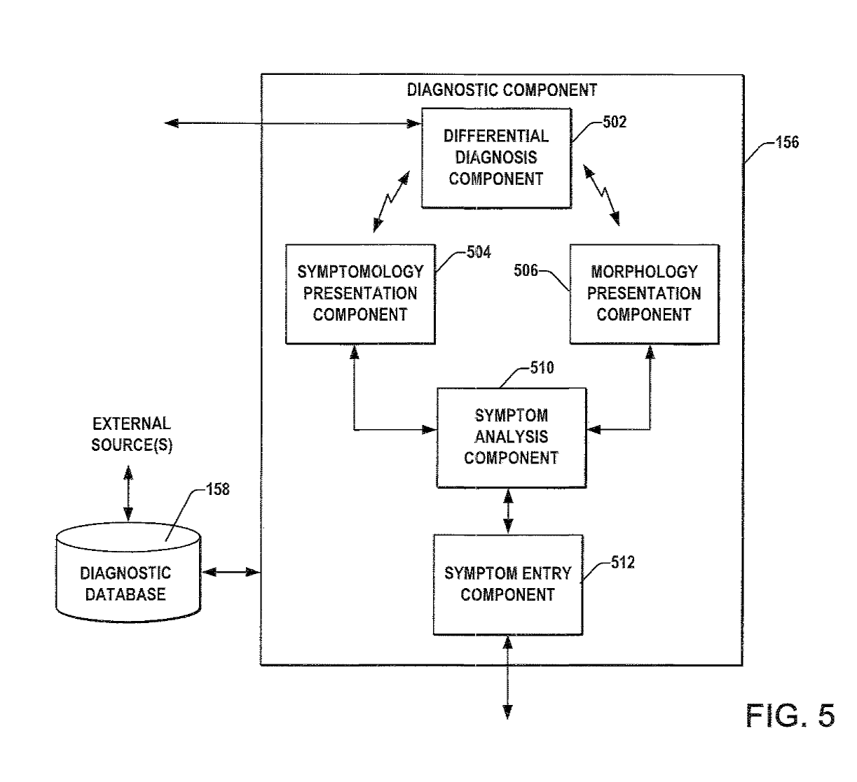

Usually, not all of these groups are used and the descriptions of the patient's lesions are shorter. However, the above template can serve as an orderly way to generate the text of the skin lesion(s) description sentence. No matter at what time an attribute from the FIG. 5 is selected, it can always go in the predefined part of the sentence. The following rules is used in the process of sentence generation:

Some of the attributes (e.g., Color) includes only one possibility that is entered in the text. That is it is either pink or white.

Other attributes can allow for multiple attributes to be entered in the text (e.g., polycyclic and round (Shape), hypertrophic, oozing, tender (Modifiers))

In addition to individual selection of these descriptive elements as outlined above, the system can contain a set of predefined descriptions. These descriptions can serve as a short cut to describing common lesions. These predefined descriptions is named based on a diagnosis. For instance, Basal Cell Carcinoma (BCC) is a skin cancer that which usual description is “white pearly papule with arborizing telangiectasia.” Instead of selecting these descriptors from the FIG. 5 each and every time dermatologist sees BCC on patients, selecting “BCC” diagnosis from the system can generate “white pearly papule with arborizing telagniectasia” text automatically, saving the time for the provider.

Managing Diagnoses

Formally speaking, during PEx, provider includes to add objective findings of the problem first, and then, during the Assessment to decide about the diagnosis (diagnoses). Physical findings are entered descriptively (see Physical Examination section above). Body mapping component 152 can allow providers to skip word-by-word description when they suspect certain diagnoses. For instance, instead of selecting from the descriptors word-by-word “white pearly papule with arborizing telangiectasia” for suspecting diagnosis of Basal Cell Carcinoma (aka BCC), the provider can select BCC button and the text “white pearly papule with arborizing telangiectasia” can appear in the PEx section of the affected body part, saving the time for the provider.

Lesion Documentation Process:

The attributes that are selected when describing a lesion(s) are listed below. The attributes can be haphazardly selected without any particular order.

Diagnosis (Clinical Impression)

Modification of Clinical Description

When we use Clinical Impression in order to get generic text for the Clinical Description of a lesion, often this text can need to be modified, as not all BCC's are the same. With this attribute the Provider is able to achieve this modification.

Multiplicity

Single (Default)

Describes only one skin lesion

Multiple

Describes one type of skin lesion in multiple locations

Laterality

Unilateral

Bilateral (Check Box)—Mode

Allows entries to be bilaterally entered. One entry mirrors on the contra-lateral side

Distribution

Haphazard/Scattered (default)

It is at the Provider's discretion where to document the lesion(s)

Generalized (Widespread)

The entire body is selected

Provider can deselect some regions if the rash involved most of the body but not the entire body

Regional

Describes a selected region of the body that is affected with the skin problem

Multiple regions can be selected

Photosensitive

Provider can deselect some regions

Acral

Provider can deselect some regions

Dermatomal

Intertrigenous

Provider can deselect some regions

Webspaces

Provider can deselect some regions

Nails

Fingernails

Toenails

Provider can deselect some regions

Periungal

Fingernails

Toenails

Provider can deselect some regions

Anatomic Location:

Body Parts (i.e., Head, Neck, Trunk, Pelvis, Upper/Lower Extremities)

Body Regions (e.g., Upper Arm, Lower Arm, etc)

Detailed (e.g., Proximal Nail Fold)

BSA Free Draw Mode

Size

Explicit size

Two unit options: Millimeters or Centimeters

Size Range

Triangulation

Counting

Approximate Number Mode

Sometimes you need to document an approximate number of lesions (e.g., actinic keratoses)

Terms such as (below) may be used

Several (more than two but not many: [as adj.] the author of several books|[as pron.])

Few ((a few) a small number of)

Many (a great/good deal of, a lot of, plenty of, countless, innumerable, scores of, crowds of, droves of, an army of, a horde of, a multitude of, a multiplicity of, multitudinous, multiple, untold; several, various, sundry, diverse, assorted, multifarious; copious, abundant, profuse, an abundance of, a profusion of; informal lots of, umpteen, loads of, masses of, stacks of, scads of, heaps of, piles of, bags of, tons of, oodles of, dozens of, hundreds of, thousands of, millions of, billions of, zillions of, gazillions of, a slew of, a boatload of, more—than one can shake a stick at; literary myriad, divers. antonym few.)

Multiple (having or involving several parts, elements, or members: multiple occupancy|a multiple birth, numerous and often varied: words with multiple meanings.)

Myriad (a large/great number, a large/great quantity, scores, quantities mass, host, droves, a horde; informal lots, loads, masses, stacks, scads, tons, hundreds, thousands, millions, gazillions.)

Scattered (be scattered) [usu. with adverbial] occur or be found at intervals rather than all together

Scattered Multiple

Scattered Few

Scattered Grouped

Affected Body Surface Area

For problems, like rash, which manifest themselves on a specific area on the skin, the system should compute the Affected Body Surface Area (ABSA). ABSA is a ratio of the body surface area affected by the specific problem and the total body surface area. When doing this calculation, the system should also take Body Mass Index (BMI) into consideration—for instance, obese patients (higher BMI) have greater total body surface then patients with normal BMI, and therefore lower Affected Body Surface Area.

Equation:

ABSA=(Area Affected by Dermatologic Condition)/(Total Body Area) *BMI Factor

The MPS can employ an equation to calculate BMI Factor (this factor can depend on BMI value)

Note: ABSA is not an exact measurement of the BSA affecting the patient, but rather an approximate estimation of the BSA affected by the rash based on approximate outline of the rash that the provider drew on the body mapping component 152.

In addition to providing the value for this parameter, the system can also provide a chart view so that (positive/negative) trends can be observed by the provider, in the context of previous encounters. That is, if the rash is involving less of the BSA on the follow-up appointment than on the initial appointment—then this documentation serves as an objective finding that the rash is improving and vice versa.

Note: Traditionally, dermatologists use BSA estimation from the following models:

System can automatically calculate ABSA (on the fly), but it is up to the Provider whether he/she can want to include ABSA in the PEx and Assessment parts of the Progress Note. That is, UI can allow him to quickly add this information to the note if so desired.

ABSA can be calculated in one of several ways:

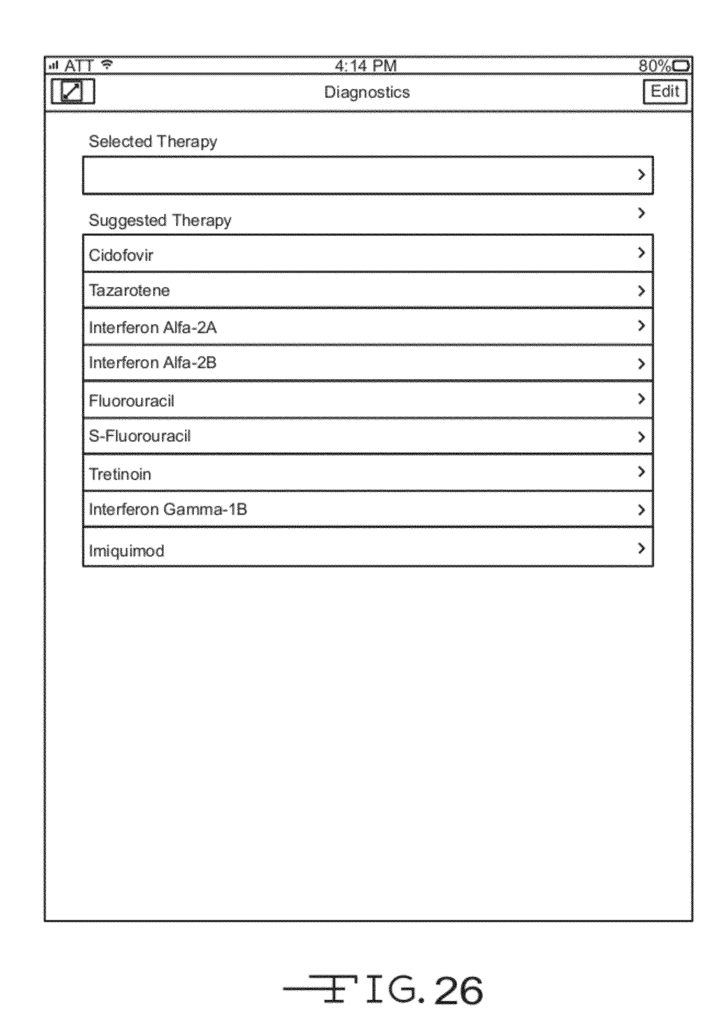

A Provider selects body region(s)—selecting them individually or using any of the Distribution patterns mentioned above—and by right click enters his estimation of what area of that region is affected by the dermatologic condition. Note that the region in question is 100%. After the percentage is entered, the system can take this into the account and add percentages of each system to come with total ABSA. For instance, psoriasis ABSA (FIG. 26) is estimated to be 35% of the lady's Back (100%). If only the back was affected by psoriasis, then ABSA for the whole body would be 6.3%. (According to the Standard BSA Values the Back (Posterior Torso) affects 18% of BSA, 35% of 18%=8.3%. Therefore, ABSA in our example is 6.3%).

Hardware Implementation

In order to provide a context for the various aspects of the invention, the following is intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practices on standalone computers. In a distributed computing environment, program modules may be locate in both local and remote memory storage devices.

A computer illustrates one possible hardware configuration to support the systems and methods described herein. In order to provide additional context for various aspects of the present invention, the following discussion is intended to provide a brief, general description of a suitable computing environment in which the various aspects of the present invention may be implemented. Those skilled in the art will recognize that the invention also may be implemented in combination with other program modules and/or as a combination of hardware and software. Generally, program modules include routines, programs, components, data structures, etc., that perform particular tasks or implement particular abstract data types.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices.

The computer can utilize an exemplary environment for implementing various aspects of the invention, wherein the computer includes a processing unit, a system memory and a system bus. The system bus couples system components including, but not limited to the system memory to the processing unit. The processing unit may be any of various commercially available processors. Dual microprocessors and other multi-processor architectures also can be employed as the processing unit.

The system bus can be any of several types of bus structure including a memory bus or memory controller, a peripheral bus and a local bus using any of a variety of commercially available bus architectures. The system memory can include read only memory (ROM) and random access memory (RAM). A basic input/output system (BIOS), containing the basic routines that help to transfer information between elements within the computer, such as during start-up, is stored in the ROM.

The computer can further include a hard disk drive, a magnetic disk drive, e.g., to read from or write to a removable disk, and an optical disk drive, e.g., for reading a CD-ROM disk or to read from or write to other optical media. The computer can include at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

A number of program modules may be stored in the drives and RAM, including an operating system, one or more application programs, other program modules, and program data. The operating system in the computer can be any of a number of commercially available operating systems.

In addition, a user may enter commands and information into the computer through a keyboard and a pointing device, such as a mouse. Other input devices may include a microphone, an IR remote control, a track ball, a pen input device, a joystick, a game pad, a digitizing tablet, a satellite dish, a scanner, or the like. These and other input devices are often connected to the processing unit through a serial port interface that is coupled to the system bus, but may be connected by other interfaces, such as a parallel port, a game port, a universal serial bus (“USB”), an IR interface, and/or various wireless technologies. A monitor or other type of display device, may also be connected to the system bus via an interface, such as a video adapter. Visual output may also be accomplished through a remote display network protocol such as Remote Desktop Protocol, VNC, X-Window System, etc. In addition to visual output, a computer typically includes other peripheral output devices, such as speakers, printers, etc.

A display can be employed with the computer to present data that is electronically received from the processing unit. For example, the display can be an LCD, plasma, CRT, etc. monitor that presents data electronically. Alternatively or in addition, the display can present received data in a hard copy format such as a printer, facsimile, plotter etc. The display can present data in any color and can receive data from the computer via any wireless or hard wire protocol and/or standard.

The computer can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system to facilitate medical services as hereinabove described.

2. A method to facilitate medical services as hereinabove described.

3. A system that employs means for facilitating medical services as hereinabove described.
